(19) United States
(12) Patent Application Publication
(10) Pub. No.: US 2015/0159917 A1
(43) Pub. Date: Jun. 11, 2015

(54) METHOD AND APPARATUS OF USING HEAT GENERATED BY SINGLE WELL ENGINEERED GEOTHERMAL SYSTEM (SWEGS) TO HEAT OIL LADEN ROCK OR ROCK WITH PERMEABLE FLUID CONTENT FOR ENHANCE OIL RECOVERY

(71) Applicant: GTherm Inc., Westport, CT (US)

(72) Inventors: Michael J. Parrella, Weston, CT (US); Bruce H. Dubow, Easton, CT (US)

(21) Appl. No.: 14/394,030

(22) PCT Filed: Dec. 17, 2012
(86) PCT No.: PCT/US12/70115

§ 371 Date: Oct. 10, 2014

Related U.S. Application Data
(60) Provisional application No. 61/576,719, filed on Dec. 16, 2011.

(51) Int. Cl. F24J 3/08; E21B 36/00; E21B 43/24

(52) U.S. Cl. CPC F24J 3/08; E21B 43/24; E21B 36/006

(57) ABSTRACT

Apparatus is provided having a heat extraction system for generating geothermal heat from within a drilled well, comprising: a heat conductive material injected into an area within a heat nest near a bottom of a drilled well between a heat exchanging element and rock, and any fluid around the rock, surrounding the heat nest to form a closed-loop solid state heat exchange to heat contents of a piping system flowing into and out of the heat exchanging element at an equilibrium temperature at which the rock surrounding the heat nest and generating the geothermal heat continually recoups the geothermal heat that the rock is conducting to the heat conductive material.

### CROSS REFERENCE TO RELATED APPLICATIONS

This application claims benefit to provisional patent application Ser. No. 61/576,719, filed 16 Dec. 2011, which is hereby incorporated by reference in its entirety.

### BACKGROUND OF THE INVENTION

1. Field of Invention

The present invention relates to the field geothermal energy; and more particularly relates to using a single-well engineered geothermal system (SWEGS) for use in enhanced oil recovery in oil fields, oil storage tanks and oil pumping system.

2. Description of Related Art

FIG. 1a shows a single-well engineered geothermal system (also known hereinafter as “SWEGS”) generally indicated as 10 disclosed in U.S. patent application Ser. No. 12/456,434, which corresponds to U.S. Patent Publication no. US 2009/0320475 (Atty docket no. 800-163.2), which discloses a closed-loop, solid-state system that generates electricity from geothermal heat from a well by flow of heat, without needing large quantities of water to conduct heat from the ground. The SWEGS takes the form of a heat extraction system for generating geothermal heat from within a drilled well, having a heat conductive material injected into an area within a heat nest near a bottom of a drilled well between a heat exchanging element and rock or rock with a permeable fluid content surrounding the heat nest to form a closed-loop solid state heat exchange to heat contents of a piping system flowing into and out of the heat exchanging element at an equilibrium temperature at which the rock or rock with a permeable fluid content surrounding the heat nest and generating the geothermal heat continually recoups the geothermal heat that the rock or rock with a permeable fluid content is conducting to the heat conductive material and above which the geothermal heat generated by the rock or rock with a permeable fluid content surrounding the heat nest dissipates as the heat conductive material conducts heat from the rock or rock with a permeable fluid content surrounding the heat nest to the heat exchanging element. The heat nest is understood to be an area between a heat point and the bottom of the well that is constructed at a desired depth after a surface area of the surrounding rock or rock with a permeable fluid content has been increased to ensure a maximum temperature and flow of geothermal generated by the rock (and any fluid around the rock), and the heat point is understood to be the lowest depth where an appropriate heat is encountered, consistent with that disclosed in the aforementioned U.S. Patent Publication no. US 2009/0320475, e.g., including paragraph [0032] through [0034] and FIG. 5 therein. The heat conductive material may be configured to solidify to substantially fill the area within the heat nest to transfer heat from the rock surrounding the heat nest and the heat exchanging element. The heat conductive material may include, or take the form of, any substance or material that conducts heat at the temperature required within the well, e.g., including substances or materials like grout, enhanced grout, plastic, ceramics, enhanced ceramics, molten metal such as for instance copper, or any combination of these substances or materials, consistent with that disclosed in paragraph [0049] of the aforementioned U.S. Patent Publication no. US 2009/0320475. The heat conductive material may stabilize pressure on the piping system and the heat exchanging element within the heat nest. The piping system may be configured to bring the contents from a surface of the well into the heat nest and carry heated contents to the surface of the well from the heat nest. The closed-loop solid state heat exchange may be configured to extract geothermal heat from the well without exposing the rock or rock with a permeable fluid content surrounding the heat nest to an externally induced liquid flow, by receiving cold fluid 11 and providing heated contents or hot fluid 12 to the piping system for further processing.

The SWEGS uses commercially-available components in an innovative process that is cost competitive with conventional fossil fuel-based power generation technologies. The heat nest harvests geothermal heat from a single well to inexpensively produce a cost competitive, consistent supply of reliable and totally green thermal energy. The SWEGS technology may be used to tap widely-available ‘hot dry rock’ to produce geothermal energy. It requires no fracturing of the earth, no injection of water, and does not create seismic or hydrologic disruption. In addition, it creates no water or air pollution, and produces renewable thermal energy with substantially no carbon footprint.

As a “base load” (24/7) source of energy, the SWEGS geothermal energy may be used to produce electricity at a greater capacity (90+%) than any other source of power. Nuclear power is second in power generation capacity efficiency, but is not distributable, takes a very long time to build, is very expensive to build and presents significant risks during plant operation and for hundreds of years later.

Different embodiments of the SWEGS may include one or more of the following: The equilibrium temperature may be increased by increasing the surface area of the rock or rock with a permeable fluid content surrounding the heat nest, and may be in a range of temperatures determined at least in part by a surface area of the rock or rock with a permeable fluid content within the heat nest. At least one additional bore hole may be drilled into the rock or rock with a permeable fluid content to increase the surface area of the rock; at least one additional material may be injected into the heat nest, including at least one or more of the following: a ball bearing, a bead, a meshed metallic material, a heat conductive rod, a heat pipe, a foam, a metal, a plastic, or any other highly conductive material. The piping system may include a set of flexible downward-flowing pipes that carry the contents of the piping system into the heat exchanging element, and a set of flexible upward-flowing pipes that carry the contents of the heat exchanger out of the heat exchanging element. The downward-flowing pipes and upward-flowing pipes each may include a plurality of layers of wound corrosion resistant steel heat insulating material. The heat exchanging element may include a plurality of capillaries. The contents of the downward-flowing pipes may be dispersed through the plurality of capillaries after entering the heat exchanging element. Each capillary in the plurality of capillaries has a diameter smaller than a diameter of the downward-flowing pipes, thereby allowing the contents of the piping system to heat quickly as the contents pass through the plurality of capillaries. The contents of the piping system may be an environmentally inert, heat conductive fluid that does not boil when heated within the heat nest or water under pressure. By way of example, the contents of the piping system may be water, a fluid designed for heat exchanger or a gas under pressure. The heat exchanging element may have a helix shape in which the piping system within the heat exchanging element comprises at least one twisted pipe to increase the distance contents of the piping system flows within the heat exchanging element.

### FIG. 1 b: SWEGS: Creating Steam Generation

In FIG. 1 b, the SWEGS 10 may be used in conjunction with a heat exchanger in order to convert cold water 14 into steam 15 as shown. By way of example, the steam may be used to generate electricity in a power plant, consistent with that disclosed U.S. Patent Publication no. US 2009/0320475. The SWEGS 10 uses commercially-available components in an innovative process that is cost competitive with conventional fossil fuel-based electric power generation technologies. The HeatNest™, a closed-loop geothermal heat transfer system, harvests geothermal heat from a well to produce a reliable, cost competitive, consistent supply of totally green energy. The overall technology taps widely-available ‘hot rock or hot rock with a permeable fluid content’ to produce geothermal energy, where ‘hot rock or hot rock with a permeable fluid content’ is understood to be rock or rock that contains brine, water or fluid. (As a person skilled in the art would understand and appreciate, if rock having little or no fluid around the rock (e.g. solid dry rock) has a heat flow with a factor of X, then any fluid around the rock is likely to increase the heat flow by an order of magnitude at least 10×, e.g., in the case of permeable wet rock where convection is created, or by an order of magnitude at least 1000×, e.g. in the case of a brine flow of liquid like a river flow.) It requires no fracturing of the earth, no injection of water, and does not create seismic or hydrologic disruption. In addition, it creates no water or air pollution, and produces renewable power with a zero carbon footprint. Using SWEGS to produce steam in current steamflood (or steam drive) systems completely eliminates cost and contamination of burning fossil fuels.
Colder fluid is pumped down into the SWEGS for heating.
Heated fluid is returned to the surface and passed into a heat exchanger (heat is above the boiling point of water).
Heat is exchanged into the water creating steam.

### Other SWEGS-Related Technology

Other SWEGS-related cases have also been filed, including U.S. patent application Ser. No. 12/462,657, which corresponds to Publication no. US 2010/0276115 (Atty docket no. 800-163.3); U.S. patent application Ser. No. 12/462,661, which corresponds to Publication no. US 2010/0270002 (Atty docket no. 800-163.4); U.S. patent application Ser. No. 12/462,658, which corresponds to Publication no. US 2010/0270001 (Atty docket no. 800-163.5); and U.S. patent application Ser. No. 12/462,656, which corresponds to Publication no. US 2010/0269501 (Atty docket no. 800-163.6), which are all incorporated hereby incorporated by reference in their entirety.

By way of example, U.S. patent application Ser. No. 12/462,657 discloses a system and method of maximizing heat transfer at the bottom of a well using heat conductive components and a predictive model to design and implement a closed-loop solid state heat extraction system.

U.S. patent application Ser. No. 12/462,661 discloses a heat exchanger that transfers heat from solid state heat conducting material to a fluid in a closed-loop system.

U.S. patent application Ser. No. 12/462,658 discloses a method of transferring heat using grout that has been optimized to protect the materials from the corrosive environment and to allow for heat transfer includes a heat conductive particulate mixed with the grout. For example, in cases where the corrosive environment is not severe or of concern, embodiments may be implemented without using the grout, such that fluid flows directly around the heat exchanger, which increases the throughput by as much as 10×, and possibly even higher in the case where there is convection flow.

U.S. patent application Ser. No. 12/462,656 discloses a control system manages and optimizes a geothermal electric generation system from one or more wells that individually produce heat. The grout can also be treated to protect the SWEGS components from caustic well environments.

All of the aforementioned patent applications are incorporated by reference in their entirety.

### Other SWEGS-Related Applications

Additional patent applications have been filed relating to the design of the cooling component of the technology as well as other applications of the SWEGS technology such as water purification, or heat for the leaching process in mining, greenhouse, fish farming, cooling/heating, remediation, mining, pasteurization and brewing applications. For example, the overall SWEGS technology may be used to produce base load electricity, and also use it to power a desalination process, converting salt water to fresh water making it suitable to drink or use for irrigation. If the geological conditions do not support the generation of electricity, the SWEGS technology may be used as a “Green Boiler” to provide thermal energy for the desalination of salt water or purification of brackish water.

### ColdNest Technology

For example, a companion application disclosing ColdNest technology, is identified as PCT patent application serial no PCT/US12/36498 (Atty docket no. 800-163.7-1), which claims benefit to an earlier filed provisional patent application Ser. No. 61/482,332, filed 4 May 2011 (Atty docket no. 800-163.7), which is also incorporated by reference in their entirety. This companion application sets forth still an alternative embodiment to the basic SWEGS technology by incorporating, e.g., a ColdNest and optional cooling tower, and disclosed in detail in this companion application. In effect, the ColdNest™ concept involves using the Earth for cooling and a process for using the SWEGS for direct heating and cooling. These inventions may be used to expand the overall SWEGS technology into areas such as: water purification, water desalination, HVAC, remediation, EOR, mining, etc.

### SWEGS-Based Cooling/Heating, Remediation, Mining, Pasteurization and Brewing Applications

Moreover, other SWEGS-related applications have also been filed, including PCT/US12/36521, filed 4 May 2012, which claims benefit to U.S. provisional patent application nos. 61/576,719 (Atty docket no. 800-163.8). This application sets forth further applications of the basic SWEGS technology in the areas of cooling/heating applications, remediation applications, mining applications, pasteurization applications and brewing applications. By way of example, the application discloses apparatus featuring a heat extraction system (i.e. the SWEGS) in combination with some further apparatus for implementing some further functionality, e.g., associated with the aforementioned cooling/heating, remediation, mining, pasteurization and brewing applications.

Finally, provisional patent application Ser. No. 61/576,700 (Atty docket no. 800-163.10), filed 16 Dec. 2011, which is also incorporated hereby incorporated by reference in their entirety.

The SWEGS technology disclosed in all these patent applications provides an important contribution to the state of the art of geothermal energy, including in the area of generating electricity, and also including in the area of heat extraction from the earth, e.g., to generate electricity. The SWEGS technology also represents a renewable green heat generator technology.

### Oil Recovery

Traditionally, oil fields have largely been exploited through natural depletion: engineers drill a hole and the pressure in the reservoir forces out the oil. This conventional process is only able to recover about 20% of the original oil in the reservoir, leaving up to 80% of the known oil in place stranded (USGS). Differences in viscosity and the effect of interactions among the down-hole environment, water and oil also hampers recovery percentages.

Over the decades, energy companies have developed procedures that include injecting water, chemicals or gas into the reservoir to force out more of the oil, boosting the recovery factor to around 30% (which is known as secondary extraction which comes in the form of CO₂ or water flooding). The remaining 70% of the oil in place is left in the ground.

The discovery and recovery of “easy oil” is disappearing. Much of the planet's untapped reserves are either deep beneath the sea or in environmentally sensitive areas making new fields expensive. According to the International Energy Agency (IEA), boosting oil recovery in the United States could help to unlock an additional 300-to-400 billion barrels of the more than 1 trillion barrels of oil still in the ground in the United States.

This has triggered a revaluation of, and given momentum to a suite of conventional highly viscous oil recovery techniques—injecting steam, chemicals or gas into a reservoir or burning the oil in place to create heat—to ease the flow of oil and recover 30% to 60%, or more of the stranded oil reservoirs.

Although such known techniques tend to be seen as a relatively modern solution to the problem of dwindling oil reserves, they actually has been around for quite some time.
CO₂ gas and water injection are the most widely used EOR technique to boost the pressure in a well as well as reduce the viscosity of oil and to sweep oil toward a production well. This technique only works for light crude oil.
Department of Energy (DOE) estimated in 2006 that ROZs (Residual Oil Zones) could contain 100 billion bbl of the 1.124 trillion bbl of technically recoverable oil in place in US reservoirs (OGJ, Mar. 13, 2006, p. 30).
Chemical injection can be used to boost recovery by decreasing the viscosity of injected water, while solutions of surfactants can help reduce the capillary forces that impede oil droplets from moving through a reservoir.

Thermal EOR can be used to heat oil in order to reduce its viscosity and allow it to flow. Steam injection is the most widely used EOR technique.

Current methods of EOR are all environmentally challenging, use and contaminate huge quantities of water (e.g. 10 to 1 re water to oil recover), and/or burn a fossil fuel like oil or gas to create the required heat. All of the inventive approaches described herein eliminate the use of fossil fuel to create the necessary heat. See, e.g., Table 1 on page 49 of a document ANL/EVS/R-08/4, entitled “Water Issues Associated with Heavy Oil Production,” by the Argonne National Laboratory, which shows water requirements for different types of oil shale plants (in acre-feet/year) as follows:

| Production (bbl/day) | | | | |
|---|---|---|---|---|
| 50,000 | 100,000 | 50,000 In | 400,000 | 1,000,000 |
| Underground | Surface Mine | Situ | Technology Mix | Technology Mix |

Process Uses

| | | | | | |
|---|---|---|---|---|---|
| Mining and | 370-510 | 730-1,020 | n/a | 2,600-3,600 | 6,000-8,000 |
| Crushing | | | | | |
| Retorting | 580-730 | 1,170-1,460 | n/a | 4,100-5,100 | 9,000-12,000 |
| Shale Oil | 1,460-2,190 | 2,920-4,380 | 1,460-2,200 | 11,700-17,500 | 29,000-44,000 |
| Upgrading | | | | | |
| Processed | 2,900-4,400ₐ | 5,840-8,750ₐ | n/a | 20,400-30,900 | 47,000-70,000 |
| Shale | | | | | |
| Disposal | | | | | |

Non-Process Uses

| | | | | | |
|---|---|---|---|---|---|
| Power | 800-1,110 | 1,570-2,190 | 800-1,900 | 6,300-9,800 | 16,000-25,000 |
| Production | | | | | |
| Revegetation | 0-700 | 0-700 | 0-700 | 0-4,900 | 0-12,000 |
| Sanitary | 20-50 | 30-70 | 20-40 | 200-300 | 1,000-1,000 |
| Domestic | 670-910 | 1,140-1,530 | 720-840 | 5,400-6,900 | 13,000-17,000 |
| Total | 6,800-10,600 | 13,400-20,100 | 3,000-5,700 | 50,700-79,000 | 121,000-189,000 |
| Average | 8,700 | 16,800 | 4,400 | 65,000 | 155,000 |

ₐAssumes that water used is 20% by weight of the disposed spent shale.

### Existing Methods of Thermal EOR for Boosting Oil Production

There are four main types of thermal EOR, which are based on the principle that heat makes thick, viscous oil more mobile and therefore easier to extract.

### FIG. 2a: In-Situ Combustion (Aka Fire Flooding)

In-situ combustion involves setting fire to some of the oil in a reservoir, thereby creating hot steam and gas. It is generally used as a last resort and only used in a reservoir that has high permeability (i.e. fluids can flow easily through the reservoir rock). In-situ combustion requires a heater or igniter to be lowered into the well and oxygen or air injected to enable the combustion of the oil. While some oil is lost through the burning because the heat reduces the viscosity of the oil, more of the remaining oil is extracted through a production well.

In addition, the steam generated as a by-product of in-situ combustion helps drive the oil through the reservoir to the producing wells, in a similar way to a standard gas-drive production method (i.e. the energy of the expanding gas drives the oil out of the reservoir rock and into the producing well).

### FIG. 2b: Cyclic Steam Injection

Cyclic Steam Injection is the second Thermal EOR technique, also known as ‘huff and puff’. There are no separate injection and producing wells. Instead, the injection of steam and the production of well fluids are carried out through the same well.

Steam is injected down into the reservoir to heat the immediate vicinity of the well shaft. Once the steam has been injected, the well is temporarily closed off (known in the industry as ‘shut-in’). As the hot steam meets the slightly colder reservoir rock, it condenses into hot water, giving off additional heat that further improves the oil flow. After a few days, the well can be opened again and the oil and water mix around the well can be pumped to the surface for further processing until the oil levels within this mix become too low. At this point, the whole process can be repeated. Once a flow connection between the wells has been established, it is possible to convert a cyclic steam injection project into a full steamflood (pictured below). The process also generates oily-waste water, which must be disposed of without harming the environment.

### FIG. 2c: Steamflood (or Steam Drive)

Steamflood Thermal EOR method involves continuous injection of steam into the reservoir, and works best when the reservoir has good permeability but the reservoir rock is not fractured. It also only works for low viscosity crude oil. If there were any fractures, the steam would simply head straight through those fractures and into the producing wells instead of working its way through the reservoir rock.

Once injected, the steam forms a bank in the reservoir, and as this bank spreads away from the injector, the steam begins to condense into hot water. The condensation process releases latent heat lowering the viscosity of the oil helping the oil flow more easily. An oil bank is thus pushed on ahead of the hot water front and towards the producing wells. An added spin-off is that light hydrocarbons are vaporized by the heat, and they move ahead of the steam bank, mixing with the heavier oil to make it flow more easily—in essence a steamflood takes advantage of miscible-gas EOR.

If the oil is buried 4,000 m deep or deeper, you have high pressure, high temperature and the potential of high salinity each of which degrades the effectiveness of steam EOR. Certain chemicals will disintegrate at high temperatures. For steam injection, you want to be in a low-pressure environment as generating steam at high pressure is very difficult and inefficient.

### FIG. 2d: Steam-Assisted Gravity Drainage

Steam-assisted gravity drainage (SAGD) is ideal for highly-fractured reservoirs because the steam is injected directly into the fractures in order to heat the reservoir rock and lower the viscosity of the oil it contains.

Unlike the steamflood process, the steam is not required to drive the oil through to producing wells; it just needs to get the oil flowing more easily. SAGD allows gravity to take effect, causing the oil to drain down into the fractures and then into horizontal producing wells that are situated towards the bottom of the reservoir.

One of the many challenges is the need to establish precisely how the fractures connect to each other. The process also generates huge amounts of waste water, which must be disposed of without harming the environment.

### Crude Oil Sludge

In addition to the recovery of oil having a high viscosity in an oil field, the recovery of crude in a storage tank has presented a problem in the art, which is summarized below:

Crude oils from the same geographical area can be very different due to different petroleum formation strata. An “average” crude oil contains about 84% carbon, 14% hydrogen, 1%-3% sulfur, and less than 1% each of nitrogen, oxygen, metals, and salts.

Most crude oils (oil recovered from below the earth's surface that is “untreated” or unrefined) that are transported for refining have a propensity to separate into the heavier and lighter hydrocarbons. This problem is exacerbated by:

Cool temperatures (lower than 100° C.)

High presence of paraffin

Venting of volatile components from the crude

Extended static condition during storage.

The heavier crude settles on the bottom of storage vessels as a viscous gel; also known as “tank bottoms”, or “sludge” (once called liquid coal). Sludge also produces an induced dipole force that resists separation (London Dispersion Forces, or Van der Waal bonds), The ‘heavier’ (predominantly the C20+ hydrocarbon molecules), tend to fall out of suspension within a static fluid.

Tank bottoms are a combination of hydrocarbons, sediment, paraffin and water. Tank bottoms can accelerate corrosion, reduce storage capacity and disrupt operations.

Most known technologies of treatment of oily waste (furnace, neutralization by encapsulation, dehydration in geotubes, vacuum desorption) destroy petroleum contained in the sludge.

### Oil Depot

An oil depot (sometimes called a tank farm, installation or oil terminal) is an industrial facility for the storage of oil and/or petrochemicals products and from which these products are usually transported to end users or further storage facilities. An oil depot typically has tankage, either above ground or underground, and gantries for the discharge of products into road tankers or other vehicles (such as barges) or pipelines.

Oil depots are usually situated close to oil refineries or in locations where marine tankers containing products can discharge their cargo. Some depots are attached to pipelines from which they draw their supplies and depots can also be fed by rail, by barge and by road tanker (sometimes known as “bridging”).

Most oil depots have road tankers operating from their grounds and these vehicles transport products to petrol stations or other users.

An oil depot is a comparatively unsophisticated facility in that (in most cases) there is no processing or other transformation on site. The products which reach the depot (from a refinery) are in their final form suitable for delivery to customers. In some cases additives may be injected into products in tanks, but there is usually no manufacturing plant on site. Modern depots comprise the same types of tankage, pipelines and gantries as those in the past and although there is a greater degree of automation on site, there have been few significant changes in depot operational activities over time.

### The Formation of Crude Oil Sludge

Most crude oils have a propensity to separate into the heavier and lighter hydrocarbons before refining. Such problem is often exacerbated by cool temperatures, venting of volatile components from the crude, and by the static condition of fluid during storage. The heavy ends that separate from the crude oil and are deposited on the bottoms of storage tanks/vessels are known as ‘tank bottoms’ or ‘sludge’.

Sludge is a combination of hydrocarbons, sediment, paraffin and water. It can accelerate corrosion, reduce storage capacity and disrupt operations. For oceangoing marine tankers the problems are twofold. At the end of many journeys the tankers have to go into dry dock for maintenance due to corrosion caused by slop oil settling out and coating the walls of the tanks.

Paraffin-based crude oil sludge forms when the molecular orbitals of individual straight chain hydrocarbons are blended by proximity, producing an induced dipole force that resists separation. As the heavier straight chain hydrocarbons flocculate, they tend to fall out of suspension within a static fluid, as in the case of storage tanks/vessels where they accumulate on the bottom as viscous gel commonly known as sludge or wax. This newly formed profile stratifies over time as the volatile components within the sludge are expelled with changes in temperature and pressure. The departure of such volatile components results in a concentrated heavier fractions within the sludge, accompanying with increased in density and viscosity, and decreased fluidity.

### EXAMPLE

Bitumen is crude oil so heavy, so filled with impurities, that it was not even known as oil; applicable to the Venezuela Orinoco Belt oil reserve, with reserve estimates run as high as 235 billion barrels. In the Hamaca field, an area the size of Houston that produces oil for Chevron, ConocoPhillips and the Venezuelan state company, oil now slurps through an octopus-like system of horizontal wells that reach out as far as 8,000 feet.

The drill bits are equipped with sensors that emit seismic signals measuring what they are passing through—whether rock, sandstone, fine shale, sand or clay. Ali Moshiri, Chevron's Latin America exploration and production group chief, said in that Venezuela needed $200 billion to develop the heavy oil reserves.

### Health, Safety and Environment

In relation to removal of sludge, one of the key imperatives is health, safety and environment (HSE) and the operators of a depot must ensure that products are safely stored and handled. There must be no leakages (etc.) which could damage the soil or the water table.

Fire protection is also a primary consideration.

### Conventional Methods of Reducing Crude Oil Sludge

When crude oil is stored in tanks, suspended sedimentary solids in the crude oil settle to the bottom. Because water is heavier than oil, it separates from the oil and also collects at the bottom of the tank. The bottom layer of the tank is known as basic sediment and water, or “crude oil tank bottoms.” Crude oil tank bottoms are typically drained from crude oil storage facilities and disposed of in nearby sumps.

The volume of sludge in a large diameter oil storage tank could run into thousands of tons.

Traditionally the cleaning of crude oil storage tanks can be done using one of four methods. See Paraffinic sludge reduction in crude oil storage tanks through the use of shearing and re-suspension, by Greg M. Heath, Robert A. Heath and Zdenek Dundr), which is summarized below:

### 1. Manual Cleaning

Manual cleaning is the most common and historically has been the cheapest method of tank cleaning. The cleaning is completed by entering the tank and using manual labor to move the sludge either out the door or to pumps stationed in the tank. Personnel spend long periods of time working in a toxic, flammable environment. Using this method, it is difficult to recover the usable hydrocarbons from the sludge that is removed. The majority of the sludge (which may contain such harmful compounds as H₂S, benzene and lead) is usually disposed of as hazardous waste. However, this method usually takes a long period of time, costing the tank operator money in lost storage capacity. During the clean-out period, the tank is vented to atmosphere and releases vapors that can be harmful to the environment.

### 2. Robotic Methods

Robotic methods are really a variation of the manual cleaning method, except that a remotely controlled robot is used to enter the tank and complete the labor. However, this method is very expensive and does not solve the venting and disposal problems. This is not a popular method with refinery owners and is primarily used in very dangerous environments only.

### 3. Chemical Cleaning

Chemical cleaning is gaining popularity and credibility as a method of tank cleaning. Various surfactants, solvents or bacteria are used to break down the complex molecules contained in the sludge and render them to their basic constituents—water, crude oil and particulate. However, this method relies on a chemical reaction and the speed, efficiency and thoroughness of the reaction are proportional the exposed surface area of the sludge. Therefore chemical cleaning methods require some sort of mixing apparatus or method of agitation.

### 4. Reduction Through Re-Suspension and Shearing by Fluid Jet

Reduction through re-suspension and shearing by fluid jet using the application of high-velocity fluid jets that are introduced into the full crude oil tank to re-suspending the accumulated sludge and shearing the paraffin to prolong re-suspension of the heavy hydrocarbon molecules.

The ability of a submerged fluid jet to re-suspend crude oil “sludge” is dictated primarily by the temperature-viscosity and composition-viscosity interrelationships and their effects on the efficiency of re-suspension and shearing (the ability of the system to “shear” the paraffin molecules). See FIG. 2e.

Continuous energy input required to prevent sludge formation in medium and heavy crudes is 280-375 Watts/100 m³ of volume. This ‘critical energy minimum’ can be related to a minimum critical velocity for suspension (VS) which must be maintained throughout the entire fluid volume in order to prevent sludge formation.

The majority of crude oil storage tanks in use today are under-serviced in terms of VS, resulting in uneven sludge deposition. This manifests as a sludge-free area immediately surrounding the propeller mixer, with substantial or severe deposition occurring beyond a specific radius, (rV) at which the fluid velocity drops below VS.

In order to produce a re-suspension system that is effective, losses in the pumping system must be reduced, so that this energy is transmitted as fluid velocity, in laminar flow, in order that the wax may be sheared, entrained and kept in suspension.

In sizable crude oil tanks that have been agitated for long periods of time by propeller mixers, it has been repeatedly observed that only the area near the mixer (e.g. 6-10 meter radius) is clean of wax accumulation; beyond this area wax has continued to be deposited. This observation suggests that propeller mixers do not deliver enough kinetic energy to the fluid environment to maintain all the fluid in the tank at a velocity greater than the critical velocity required to keep the paraffin molecules entrained.

But take a tank with large build-up of solids and wax, mix it all up re-suspend, the fact of the matter is that the solids are still there. In fact what has now happened is that all these solids have been mixed with what was good crude oil and contaminated that as well.

### Pipelines

Similar issues and conditions exist with respect to viscosity of oil in pipelines as to that in storage tanks, and because of this similar problems exist as well.

### Need in the Industry

The aforementioned known methods of high viscosity oil recovery are all environmentally challenging, use and contaminate water and burn oil or a fossil fuel to create the required heat. See, e.g., Table 2 on page 50 of the document ANL/EVS/R-08/4 entitled “Water Issues Associated with Heavy Oil Production,” by the Argonne National Laboratory, which shows a comparison of water requirements estimated by different authors, as follows:

| | | | Water Requirement |
|---|---|---|---|
| | | | Scaled to 100,000 |
| | Oil Production | Water Required (acre- | bbl/day Oil Production |
| Source | (bbl/day) | feet/year) | (acre- feet/year) |
| Prien (1954)ₐ | 1 million | 227,000 diverted | 22,700 diverted |
| | | 82,500 consumed | 8,250 consumed |
| Cameron and Jones | 1.25 million | 252,000 diverted | 20,000 diverted |
| (1959)ₐ | | 159,000 consumed | 13,000 consumed |
| Ely (1968) | 2 million | 500,000 | 25,000 |
| DOI (1968)ₐ | 1 million | 145,000 diverted | 14,500 diverted |
| | | 61,000-96,000 consumed | 6,100-9,600 consumed |
| DOI (1973a) | 50,000 underground mine | 8,700 | 17,400 |

| | | |
|---|---|---|
| 100,000 surface mine | 16,800 | 16,800 |
| 50,000 in-situ | 4,400 | 8,800 |
| 400,000 technology mix | 65,000 | 16,300 |
| 1 million technology mix | 155,000 | 15,500 |

| McDonald (1980) | 1.5 million | 200,000 | 13,300 |
|---|---|---|---|
| RAND (2005) | No specific value given; assume 3 bbl of water per 1 | | 14,125 |
| | bbl of oil | | |
| BLM (2008) | 50,000 mine | 6,100-9,400 diverted | 12,200-18,800 diverted |
| | | 4,900-7,400 consumed | 9,800-14,800 consumed |
| — | 200,000 in situ | 7,100-28,200 diverted | 3,550-14,100 diverted |
| | | 18,600-34,600 consumed | 2,700-10,700 consumed |

These references were not specifically viewed by the authors of this report. The
data were published in DOI (1973a).

In view of the aforementioned, there is a problem in the art and an overall need in the oil industry for better ways to recover highly viscous oil in reservoirs like oil fields, storage tanks and/or pipelines.

### BRIEF SUMMARY OF THE INVENTION

The present application sets forth further applications of the basic SWEGS technology shown and described in relation to FIG. 1a in the areas of highly viscous oil recovery. Using SWEGS generated geothermal heat instead of fossil fuel to create heat and using either steam, a reverse SWEGS, injection of hot brine or water and/or heat delivery wells to deliver heat into a heavy oil deposit will significantly improve the oil recovery by lowering thus improving the oil viscosity.

By way of example, according to some embodiment, the present invention may take the form of apparatus featuring the SWEGS in combination with substantially improved enhanced oil recovery (EOR) apparatus.

The SWEGS may be configured for generating geothermal heat from within a drilled well, and includes a heat conductive material injected into an area within a heat nest near a bottom of a drilled well between a heat exchanging element and rock or rock with permeable fluid content surrounding the heat nest to form a closed-loop solid state heat exchange to heat contents of a piping system flowing into and out of the heat exchanging element at an equilibrium temperature at which the rock or rock with permeable fluid content surrounding the heat nest and generating the geothermal heat continually recoups the geothermal heat that the rock or rock with permeable fluid content is conducting to the heat conductive material and above which the geothermal heat generated by the rock or rock with permeable fluid content surrounding the heat nest dissipates as the heat conductive material conducts heat from the rock or rock with permeable fluid content surrounding the heat nest to the heat exchanging element. The heat conductive material may be configured to solidify to substantially fill the area within the heat nest to transfer heat from the rock or rock with permeable fluid content surrounding the heat nest and the heat exchanging element. The piping system may be configured to bring the contents from a surface of the well into the heat nest and carry heated contents to the surface of the well from the heat nest. The closed-loop solid state heat exchange may be configured to extract geothermal heat from the well without exposing the rock or rock with permeable fluid content surrounding the heat nest to a liquid flow, and provide heated contents to the piping system for further processing. The SWEGS also delivers heat to a heat exchanger that heats the water or brine that is separated from the recovered oil and injected under pressure into the top of the oil reservoir. This heated pressurized fluid helps to maintain the pressure of the reservoir and to deliver heat that enhances the delivery of heat to oil to lower the oil viscosity. The EOR apparatus may be configured to receive the heated content and to further process the heated content in order to deliver heat to oil in an oil reservoir to decrease substantially the viscosity of the oil and increase substantially oil recovery of the oil in the oil reservoir, including retrieving the oil from the reservoir.

In effect, the SWEGS™ is a cost-effective alternative to burning fossil fuel in order to create the heat required for EOR. Generating geothermal heat or a ‘Heat Delivery SWEGS’ versus fossil-fuel-driven EOR techniques can deliver constant and sustainable heat into an oil reservoir (especially heavy and super-heavy oil) to significantly decrease oil viscosity (by several orders of magnitude) thus improve oil recovery. For example, heating oil lowers its viscosity and significantly improves its flow. Oil mobility is the ratio of the effective permeability to oil flow to its viscosity, which is given by the equation:

λ₀=k₀/u₀

where λ₀ is the oil mobility in mD/cp, k₀ if the oil effective permeability in mD, and u₀ is the viscosity in cp. When the viscosity is decreased by 4 fold, the oil mobility λ₀ is commensurately increased.

The EOR according to the present invention can return as much as $82.00/barrel*net of EOR expenses (analysis and assumptions attached.)

The present invention may include one or more of the following features:

### Oil Field Recovery

The oil reservoir may be, or take the form of, an underground oil field containing the oil, and the enhanced oil recovery apparatus is configured to provide the heated content to the underground oil field and to retrieve oil from the underground oil field.

The heated content may take the form of heated fluid or steam.

According to some embodiments of the present invention, the EOR apparatus may include, or take the form of at least one U-tube heat delivery well configured with a respective pump and corresponding piping for providing the heated content down into the at least one U-tube heat delivery well via input piping and back out of the U-tube heat delivery well via output piping. The EOR apparatus may include the U-tube heat delivery well being configured with a submersible oil pump that is configured to pump oil from the bottom of the U-tube heat delivery well via an oil pipe.

According to some embodiments of the present invention, the enhanced oil recovery apparatus may include a reverse heat extraction system (aka a reverse-SWEGS) having one or more heat pipes configured in one or more horizontal bore holes drilled into the oil reservoir and configured to receive the heated content.

The enhanced oil recovery apparatus may be configured with pipes or piping to provide steam from a heat exchanger coupled to heat extraction system to a steam injector that forms part of a steamflood or steam drive system.

The enhanced oil recovery apparatus may include a reverse heat extraction system configured in the underground oil field and having pipes or piping and a heat exchanger element, and configured to receive the heated content from the heat extraction system and provide the heated content to the underground oil field.

The enhanced oil recovery apparatus may include a reverse heat extraction system configured together with the heat extraction system in a single well in the underground oil field. The reverse heat extraction system may be configured to receive the heated content from the heat extraction system in the single well in the underground oil field, and provide the heated content to the underground oil field, while a submersible pump can be used apparatus to retrieve the oil.

The enhanced oil recovery apparatus, including the reverse heat extraction system, may include one or more heat pipes configured in one or more horizontal bore holes drilled into the oil reservoir. The one or more heat pipes may be placed to delivery the heat into rock or rock with a permeable fluid content that holds high viscosity oil. The one or more horizontal bore holes drilled into the oil reservoir may be drilled in any direction so that a single heat extraction system can impact oil deposits in all directions and can be used for multiple oil extraction wells. The one or more heat pipes may be configured to carry the heat from the heat exchanger into the rock or rock with a permeable fluid content containing the oil. The one or more heat pipes may be configured to provide continuous heat that allows the rock or rock with a permeable fluid content surrounding the horizontal bores to conduct the heat to the rock or rock with a permeable fluid content that is further away from the horizontal bores extending the reach of the apparatus.

The enhanced oil recovery apparatus may include a downwardly flowing pipe configured to carry hot fluid to a heat exchanger to delivery the heat into the rock or rock with a permeable fluid content that holds the high viscosity oil, and an upwardly flowing pipe configured to return cooled fluid to the surface to be reheated by the heat extraction system after the heat is exchanged.

The enhanced oil recovery apparatus may be configured to deliver the heat continuously and at a temperature that heats surrounding rock or rock with a permeable fluid content lowering the viscosity of the oil and allowing the oil to flow into the oil field itself, or a nearby extraction well. The heat can be delivered by heat injection wells or by heating the extracted brine from the oil production wells and re-injecting the brine into the reservoir.

The heat extraction system may be configured to provide the heated content to a power plant, and the enhanced oil recovery apparatus is configured to receive the heated content from the power plant having residual heat and to deliver heat content to the oil in the oil reservoir, such that the power plant can be used for, or in conjunction with, enhanced oil recovery.

The apparatus may include an oil rig configured to couple the heat extraction system to the enhanced oil recovery apparatus in relation to a surrounding body of water and a seabed.

According to some embodiments of the present invention, the apparatus may include additional wells, a pump, an oil and water/brine separator and a heat exchanger. The additional wells may include:

1. A Heat Delivery well, and

2. A Hot Water Flooding well.

The heat extraction system may be configured to transfer the heat content to the heat delivery well. The heat delivery well may be configured to transfer heat into the oil reservoir. The one or more pumps may be configured to provide oil and brine/water from a production well to the surface. The oil and water/brine separator may be configured to separate oil from the brine/water. Moreover, the heat exchanger may be configured to heat the water/brine, using heat from the heat extraction system.

### Storage Tanks

Alternatively, the oil reservoir may be, or take the form of, one or more storage tanks containing the oil, and the enhanced oil recovery apparatus may be configured to provide the heated content to the storage tank in order to the heat the oil contained therein.

The enhanced oil recovery apparatus may include a combination of one or more pumps and one or more pipes configured to provide the heated content to the one or more storage tanks that hold high viscosity oil.

The one or more pipes may be configured to provide the heated content to the bottom of the storage tank.

The enhanced oil recovery apparatus may include a heating coil configured at the bottom of the storage tank and also configured to receive the heated content from the one or more pipes.

The enhanced oil recovery apparatus may be configured to deliver the heat continuously and at a temperature that heats the oil in the one or more storage tanks lowering the viscosity of the oil.

The enhanced oil recovery apparatus may be configured to create a toroidal-convection effect to lower the viscosity of tank bottom crude oil sludge and prevent or minimize the formation of crude oil sludge.

The apparatus may include pumps configured to provide the heated content from the heat extraction system to the enhanced oil recovery apparatus, and cooled fluid from the enhanced oil recovery apparatus to the heat extraction system.

### The Pipeline

According to some embodiments of the present invention, the apparatus may include a further system or apparatus for heating of the oil recovered when being transported from the apparatus via a pipe, piping or pipeline to an EOR oil destination using one or more heaters. The one or more heaters may be configured in relation to the pipe, piping or pipeline based at least partly on a number of parameters, including the number of miles between the apparatus and the EOR oil destination, an insulation coefficient of the pipe, piping or pipeline, and the ambient temperature along the way between the apparatus and the EOR oil destination.

According to some embodiments of the present invention, the present invention may also take the form of a method that includes heating of the oil recovered when being transported from the apparatus via a pipe, piping or pipeline to an EOR oil destination using one or more heaters. The method may also include configuring the one or more heaters in relation to the pipe, piping or pipeline based at least partly on a number of parameters, including the number of miles between the apparatus and the EOR oil destination, an insulation coefficient of the pipe, piping or pipeline, and the ambient temperature along the way between the apparatus and the EOR oil destination.

### The Method

According to some embodiments, the present invention may take the form of a method featuring generating with a SWEGS geothermal heat from within a drilled well, as described above, in combination with receiving with a further apparatus the heated content and further processing the heated content in order to deliver heat to oil in an oil reservoir to decrease substantially the viscosity of the oil and increase substantially oil recovery of the oil in the oil reservoir, consistent with that set forth herein.

The method may also include one or more of the other features consistent with that set forth herein.

### Means-Plus-Function Recitation of Present Invention

According to some embodiments of the present invention, the present invention may take the form of apparatus comprising: SWEGS means in combination with receiving means for receiving the heated content and further processing the heated content in order to deliver heat to oil in an oil reservoir to decrease substantially the viscosity of the oil and increase substantially oil recovery of the oil in the oil reservoir, consistent with that disclosed herein.

### The Basic EOR Approach

According to the present invention, the SWEGS uses geothermal heat (or a ‘Heat Delivery SWEGS’) versus fossil-fuel-driven EOR techniques, to deliver constant and sustainable heat into an oil reservoir (especially heavy and super-heavy oil). The application of SWEGS significantly decrease oil viscosity (by several orders of magnitude) thus improves oil recovery.

The following inherent benefits are achieved with the SWEGS and ‘Heat Delivery SWEGS’ system:
Lower viscosity, improve flow rate
No burning of any fuel
No transportation cost for feed stock (fuel)
Base-load energy: continuous supply of heat to oil reservoir
Constant cost structure for thermal delivery (constant OpEx costs)
No water usage (except for the initial filling of the closed loop)
Increasing recovered oil from existing and “depleted” fields by 40% to 60%
No exploratory risk

Using SWEGS and Heat Delivery SWEGS Instead of Steam According to some embodiments of the present invention, a well may be drilled for the installation of the ‘Heat Delivery SWEGS’ that delivers heat from the surface into an oil reservoir to heat the oil and reduce its viscosity thereby enhancing the oil extraction, consistent with that set forth below.
The well bore may be drilled until the depth of the oil reservoir is reached.
   The bore hole around the heat exchanger may be filled with heat conductive grout or other material.
   After the heat exchanger transfers the heat to the surrounding rock (and any fluid around the rock), an upward flowing pipe returns the fluid to the surface for re-heating using the SWEGS heat.
Horizontal bore holes may also be drilled into the oil reservoir and filled with heat pipes. These horizontal bores may be strategically placed to maximize the delivery of heat into the colder rock that holds the high viscosity oil.
   Heat may be delivered through a downward flowing pipe carrying hot fluid (water or any other fluid) into a heat exchanger.
   The heat may be delivered continuously and at a temperature that heats the surrounding rock or rock with a permeable fluid content lowering the viscosity of the oil and allowing the oil to flow into the extraction wells.
   The horizontal bores can be drilled in any direction so that a single Heat Delivery SWEGS can impact the oil deposits in all directions and could be used for multiple oil extraction wells.
The heat pipes carry the heat from the heat exchanger into the rock or rock with a permeable fluid content containing the oil. Providing continuous heat allows the rock or rock with a permeable fluid content surrounding the horizontal bores to conduct the heat to rock or rock with a permeable fluid content that is further away from the horizontal bores extending the systems reach.
After the heat is exchanged and the fluid is cooled, it returns to the surface to be reheated.

### Crude Oil Sludge Solution (GCOSS) Approach

Crude Oil Sludge Solution™ (GCOSS™) processes and technology according to the present invention enable extracting high quantity/quality of petroleum from the crude oil sludge, without affecting the chemical structure of hydrocarbons, and when implemented over time will minimize formation of sludge.

For example, using the SWEGS to generate geothermal heat instead of burning fossil fuel to deliver heat to the crude oil tanks into a heavy oil deposit will significantly improve the oil recovery by improving the oil viscosity. The following inherent benefits are achieved with the SWEGS technology and the heat delivery system:
No burning of any fuel,
Deliver continuous supply of heat to oil tank,
No water usage (except for the initial filling of the closed loop),
Specific targeting of heat delivery to the bottom of the oil storage tank,
Create toroidal-convection effect (which mixes the new low viscous oil with the oil in the rest of the tank),
Lower the viscosity of the tank bottom crude oil sludge, and
Prevent or minimize the formation of crude oil sludge,

Using SWEGS to produce the thermal energy to treat crude oil sludge inside storage tanks also completely eliminates cost and contamination of burning fossil fuels.

According to some embodiments of the present invention, a well may be drilled for the installation of the ‘Heat Delivery SWEGS’ that delivers heat from the surface to the crude oil tanks to heat the oil and reduce its viscosity thereby enhancing the oil recovery, consistent with that set forth below.

For example, colder fluid may be pumped down into the SWEGS for heating.

Heated fluid may be returned to the surface and passed into a heat exchanger (heat is above the boiling point of water).

Heat may be exchanged into the water creating steam under pressure and no steam is created.

SWEGS well(s) may be drilled within the perimeter of the depot and strategically among the storage tanks. The thermal energy from a SWEGS closed loop system may be delivered into several crude oil storage tanks—via a heating coil located at the bottom of the storage tank. The constant supply of heat raises the crude oils temperature to approximately 120° C. or higher (well above ambient temperature) thereby reduces the sludge viscosity, enabling the re-suspension of the sludge into crude, and prevents new sludge from accumulating at the bottom of the storage tank.

1) The SWEGS well bore may be drilled to a depth that achieves greater than 100° C.—the temperature required to lower the viscosity of the stored crude oil.
a) Horizontal bore holes may be drilled from the well bore into the surrounding rock and filled with heat pipes. These horizontal bores may be strategically placed to maximize the delivery of heat into well bore. The heat pipes carry the heat from the far rock or rock with a permeable fluid content to the heat exchanger, providing continuous heat allows the rock or rock with a permeable fluid content surrounding the horizontal bores to conduct the heat to rock or rock with a permeable fluid content that is further away from the horizontal bores extending the systems reach.
b) The bore hole around the heat exchanger may be filled with heat conductive grout or other materials, if needed for based on a corrosive environment.

2) An upward flowing pipe returns the fluid to the surface where it is delivered to heating coils placed at the bottom of the storage tanks. The heat is delivered continuously and at a temperature that heats the surrounding rock or rock with a permeable fluid content lowering the viscosity of the oil and allowing the oil to flow.

3) After the heat is exchanged to the crude oil and the fluid is cooled, it returns to the down-hole SWEGS to be reheated, and the process continues as a large closed loop system.

### The Power Plant

In either the oil field or storage tank implementation, if there is enough heat captured in the well bore, a power plant using the SWEGS technology can be constructed and the residual heat from the power plant can be used for EOR. This scenario maximizes the IRR. If there is enough heat for a power plant. the geothermal reserves on the property become an additional asset.

### BRIEF DESCRIPTION OF THE DRAWING

FIG. 1 is a diagram of a heat extraction system (also known as SWEGS) that is known in the art.

FIG. 1 b is a diagram of the SWEGS in FIG. 1a used in conjunction with a heat exchanger in order to convert cold water into steam that is known in the art.

FIG. 2a is a diagram of an in-situ combustion technique that is known in the art and used to recover high viscosity oil from an oil field.

FIG. 2b is a diagram of a cyclic steam injection technique that is known in the art and used to recover high viscosity oil from an oil field.

FIG. 2c is a diagram of a steam flood or steam drive technique that is known in the art and used to recover high viscosity oil from an oil field.

FIG. 2d is a diagram of a thermally assisted gas-oil gravity drainage technique that is known in the art and used to recover high viscosity oil from an oil field.

FIG. 3 is a diagram of a system or apparatus having one or more SWEGS in conjunction with an enhanced oil recovery system that takes the form of a U-tube configuration for providing enhanced oil recovery of oil from an oil field, according to some embodiments of the present invention.

FIG. 4 is a diagram of a system or apparatus having one or more SWEGS in conjunction with a steamflood or steam drive system for providing enhanced oil recovery of oil from an oil field, according to some embodiments of the present invention.

FIG. 5 is a diagram of a reversed SWEGS that can be used in conjunction with an enhanced oil recovery system for providing enhanced oil recovery of oil from an oil field, according to some embodiments of the present invention.

FIG. 6a is a diagram of a system or apparatus having one or more SWEGS in conjunction with a reversed SWEGS that forms part of an enhanced oil recovery system for providing enhanced oil recovery of oil from an oil field, according to some embodiments of the present invention.

FIG. 6b is a diagram of a system or apparatus having one or more SWEGS in conjunction with a reversed SWEGS that forms part of an enhanced oil recovery system in a single well for providing enhanced oil recovery of oil from an oil field, according to some embodiments of the present invention.

FIG. 7 is a diagram of a system or apparatus having one or more SWEGS in conjunction with a power plant and an enhanced oil recovery system for providing enhanced oil recovery of oil from an oil field, according to some embodiments of the present invention.

FIGS. 8a and 8b are graphs showing heat moves through oil in the oil field through conduction.

FIG. 8c shows an illustration of heat that moves through toroidal convection of water and oil in permeable zones.

FIG. 9 is a diagram of a system or apparatus having an oil rig platform with one or more SWEGS in conjunction with one or more enhanced oil recovery systems for providing enhanced oil recovery of oil from an oil field in a seabed, according to some embodiments of the present invention.

FIG. 10 is a diagram of a system or apparatus having one or more SWEGS in conjunction with one or more storage tanks that form part of an enhanced oil recovery system for providing enhanced oil recovery of oil from the one or more storage tanks, according to some embodiments of the present invention.

FIG. 11a is a diagram of a system or apparatus having one or more SWEGS in conjunction with one or more storage tanks that form part of an enhanced oil recovery system for providing enhanced oil recovery of oil from the one or more storage tanks, according to some embodiments of the present invention.

FIG. 11 b is a diagram of a system or apparatus having one or more SWEGS in conjunction with a power plant and one or more storage tanks that form part of an enhanced oil recovery system for providing enhanced oil recovery of oil from the one or more storage tanks, according to some embodiments of the present invention.

FIG. 12 is a diagram of a system or apparatus having one or more SWEGS in conjunction with a power plant and a secure management controller, according to some embodiments of the present invention.

FIG. 13 is a diagram of a system or apparatus having one or more heaters used in conjunction with transporting oil from an apparatus or system configured for EOR to an EOR oil destination, according to some embodiments of the present invention.

FIG. 14 is a graph of viscosity (centipoises) versus oil temperature (F) showing how viscosity changes exponentially in relation temperatures changes.

FIG. 15 is a diagram of a system or apparatus having one or more SWEGS in conjunction with an enhanced oil recovery system, according to some embodiments of the present invention.

### DETAILED DESCRIPTION OF THE INVENTION

According to the present invention, the basic approach for enhanced oil recovery (EOR) consists of, or takes the form of, receiving the heated content from the SWEGS and to further process the heated content in order to deliver heat to oil in an oil reservoir to decrease substantially the viscosity of the oil and increase substantially oil recovery of the oil in the oil reservoir.

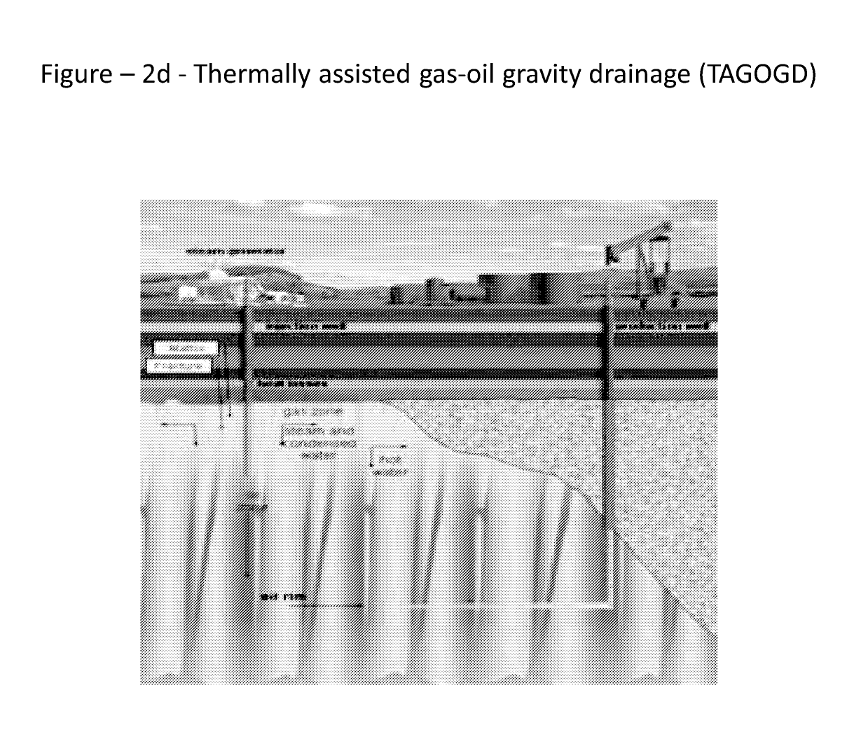

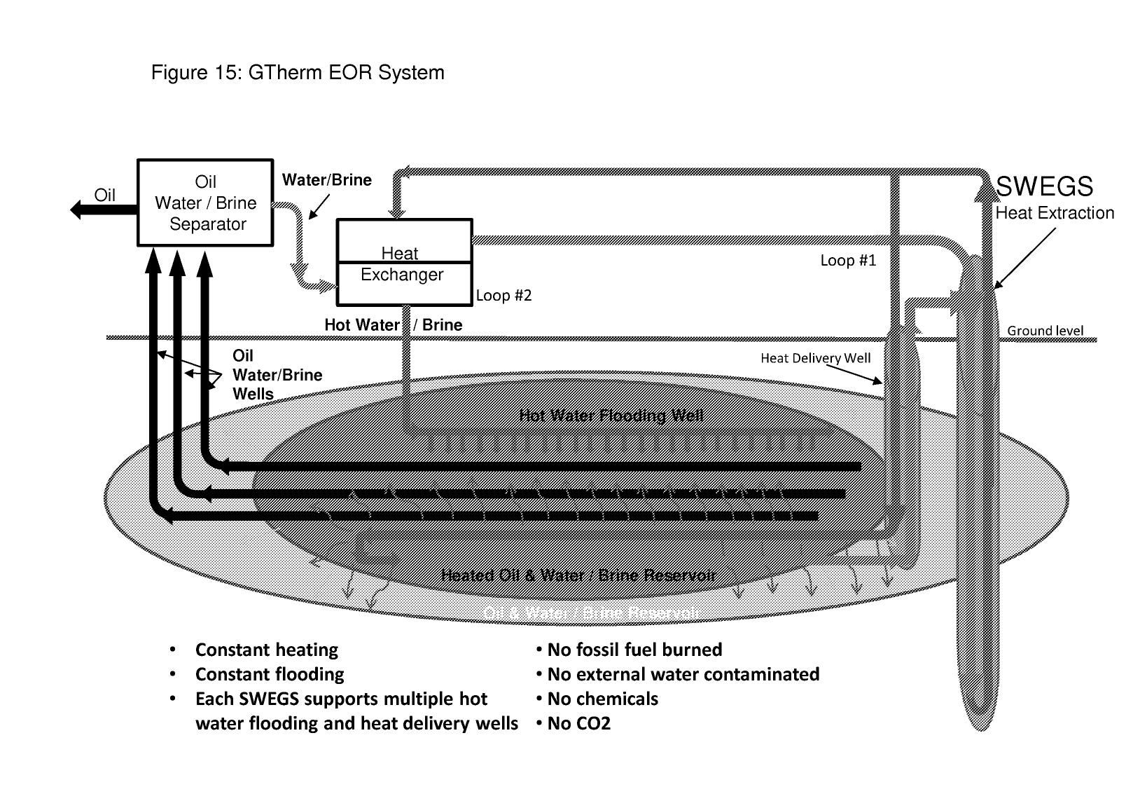

Consistent with that shown in FIGS. 3-9 and 15, the basic approach may include using SWEGS generated geothermal heat instead of fossil fuel to create heat and using either a U-tube configuration, steam, or a reverse SWEGS, or heat delivery approaches described in relation to FIG. 15, to deliver heat into a light or heavy oil deposit which will significantly improve the oil recovery by improving the oil viscosity. Using geothermal heat instead of fossil fuel to create heat and using either steam or a reverse SWEGS to deliver heat into a heavy oil deposit will significantly improve the oil recovery by improving the oil viscosity.

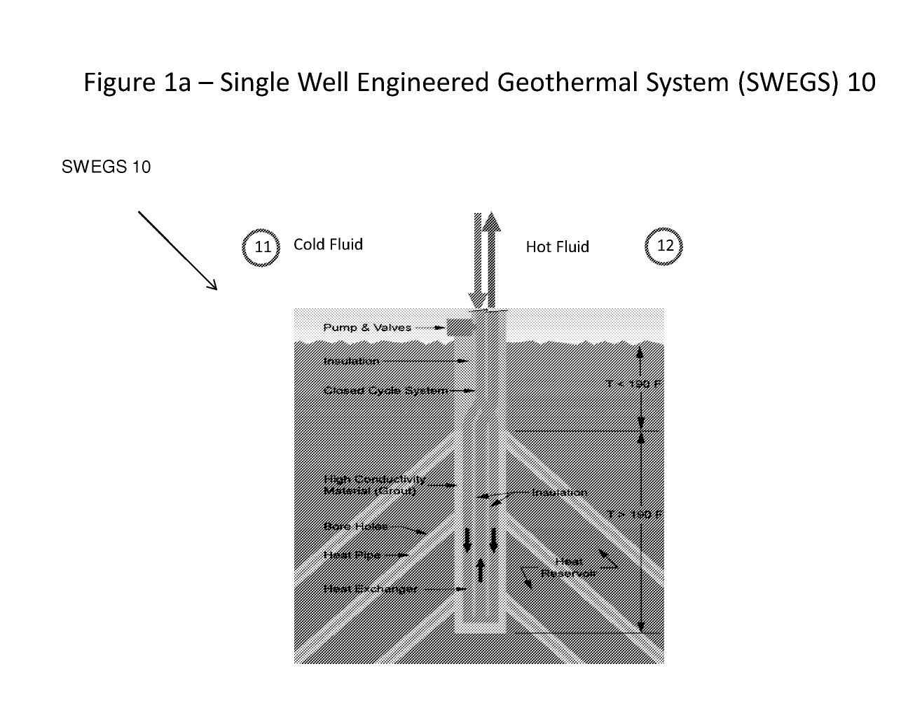

One embodiment may use a SWEGS 10 (FIG. 1a) to extract heat from the earth for use in conjunction with the U-Tube configuration, consistent with that shown and described in relation to FIG. 3.

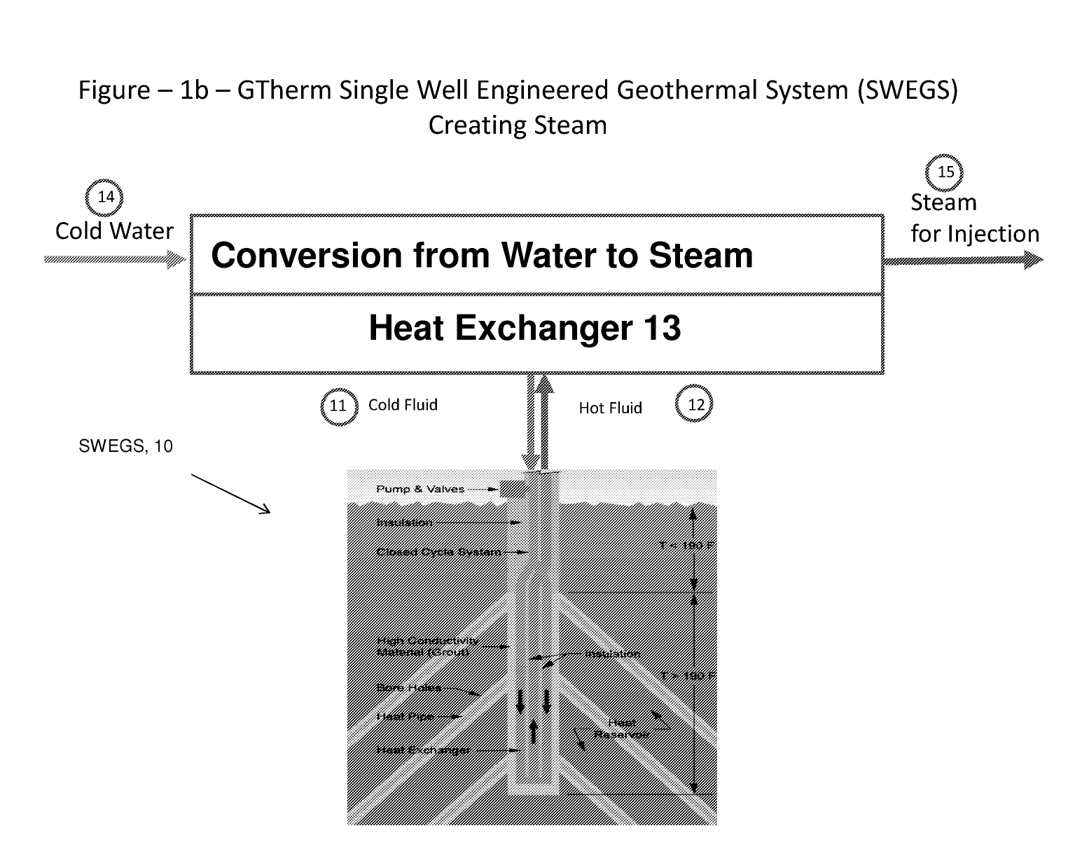

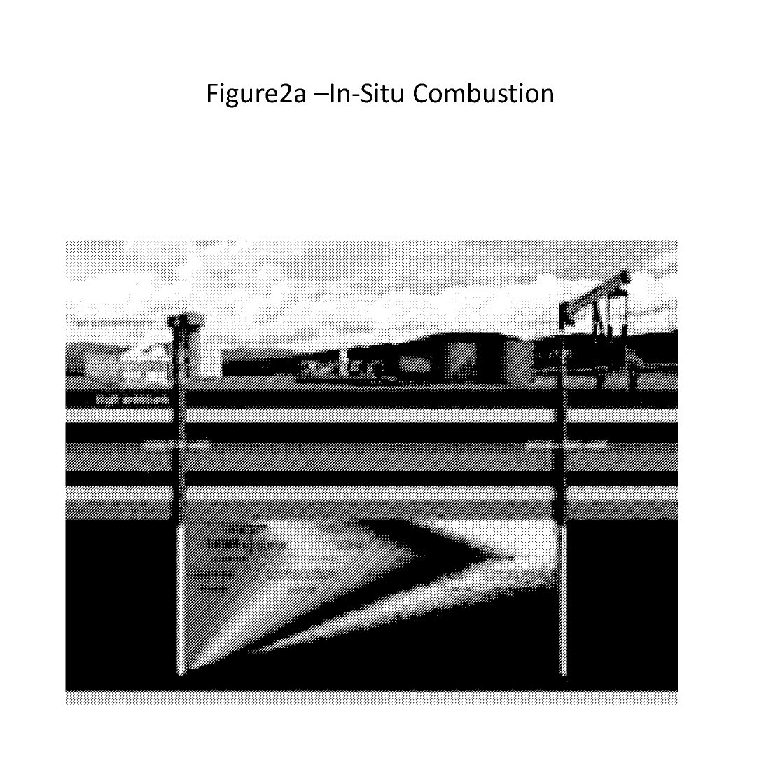

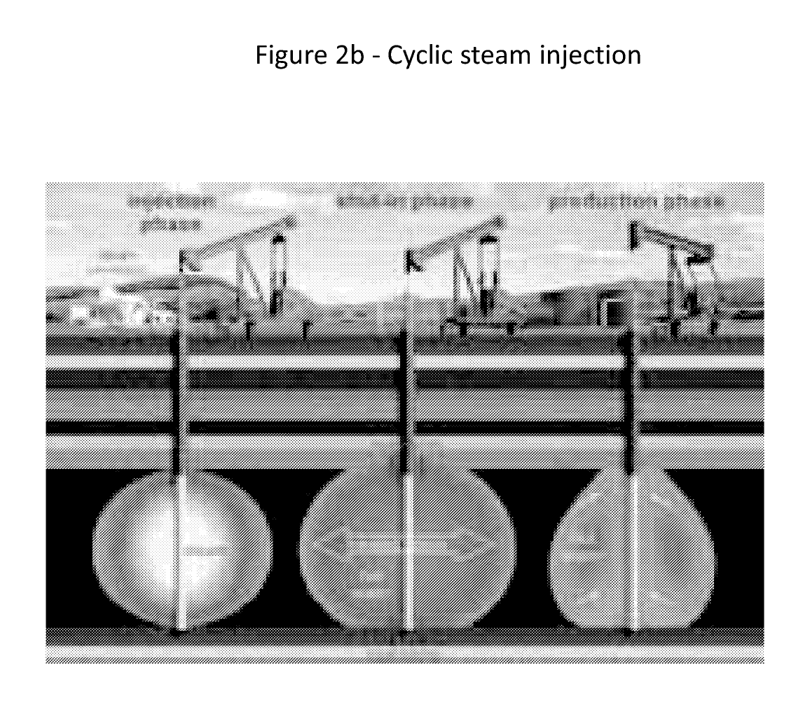

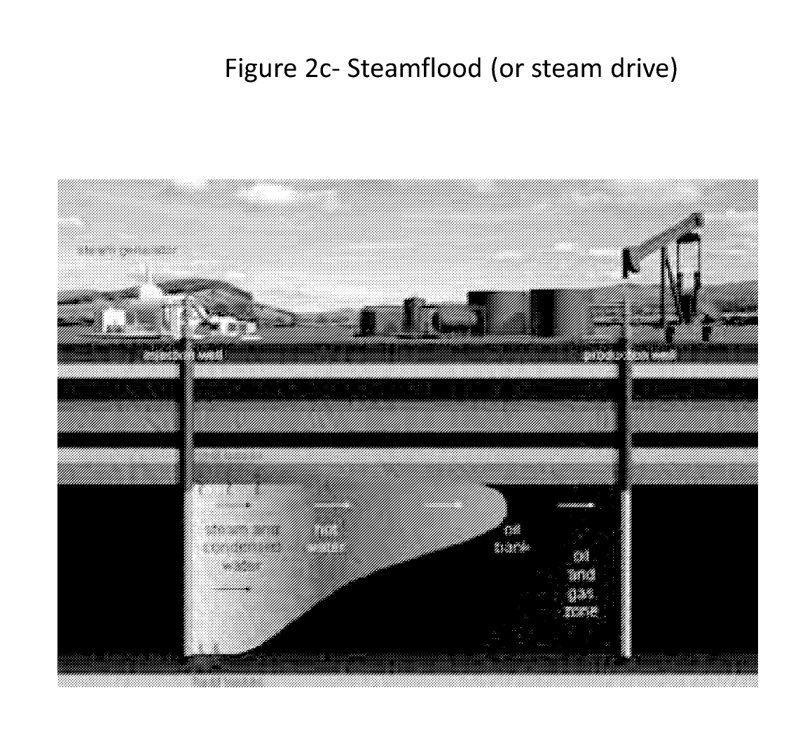

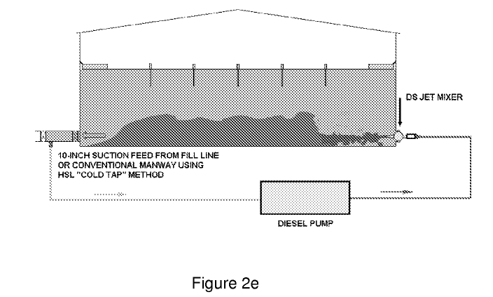

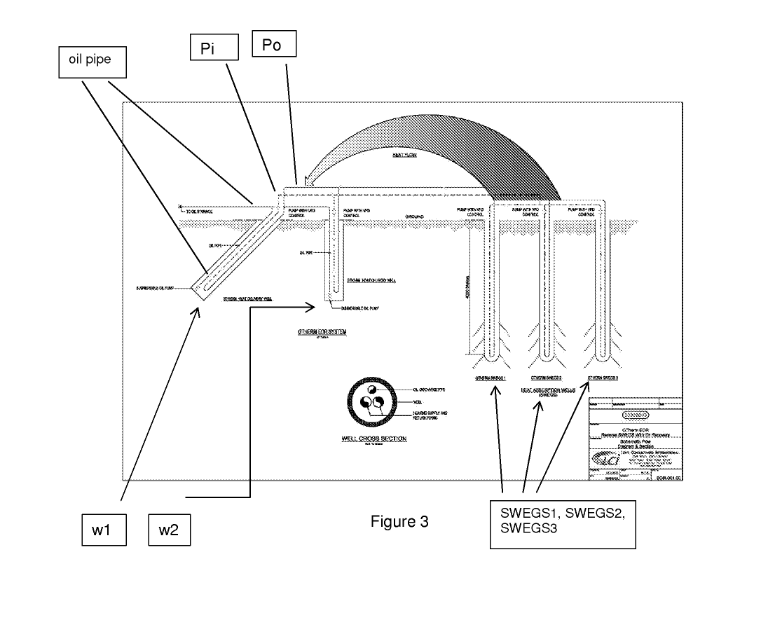

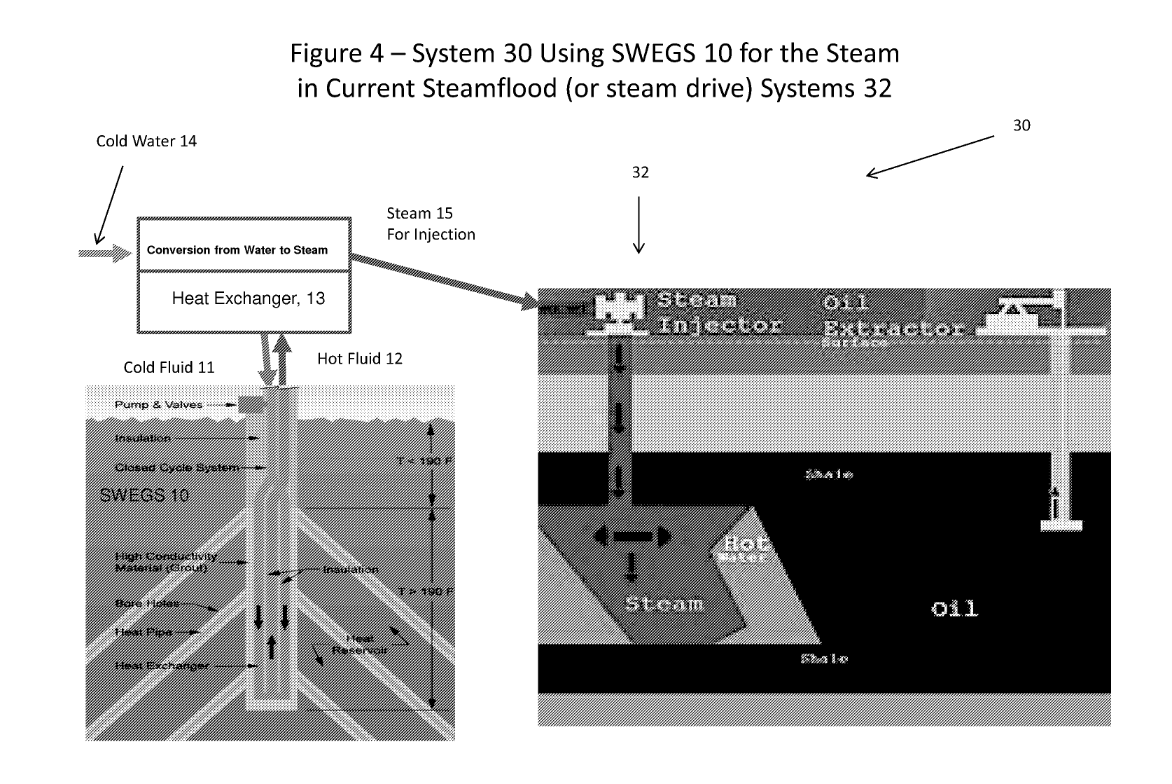

One embodiment may use a SWEGS 10 (FIG. 1a) to extract heat from the earth to create steam (FIG. 1 b) for use in conjunction with a steamflood process (FIG. 2c), consistent with that shown and described in relation to FIG. 4. One or more SWEGS 10 can be used for a field of oil wells. Once the capital or the SWEGS 10 is invested there are no fuel costs only minimal electrical costs for running the pumps and some maintenance costs. The SWEGS 10 can also be used for a steamdrive system (FIG. 2c).

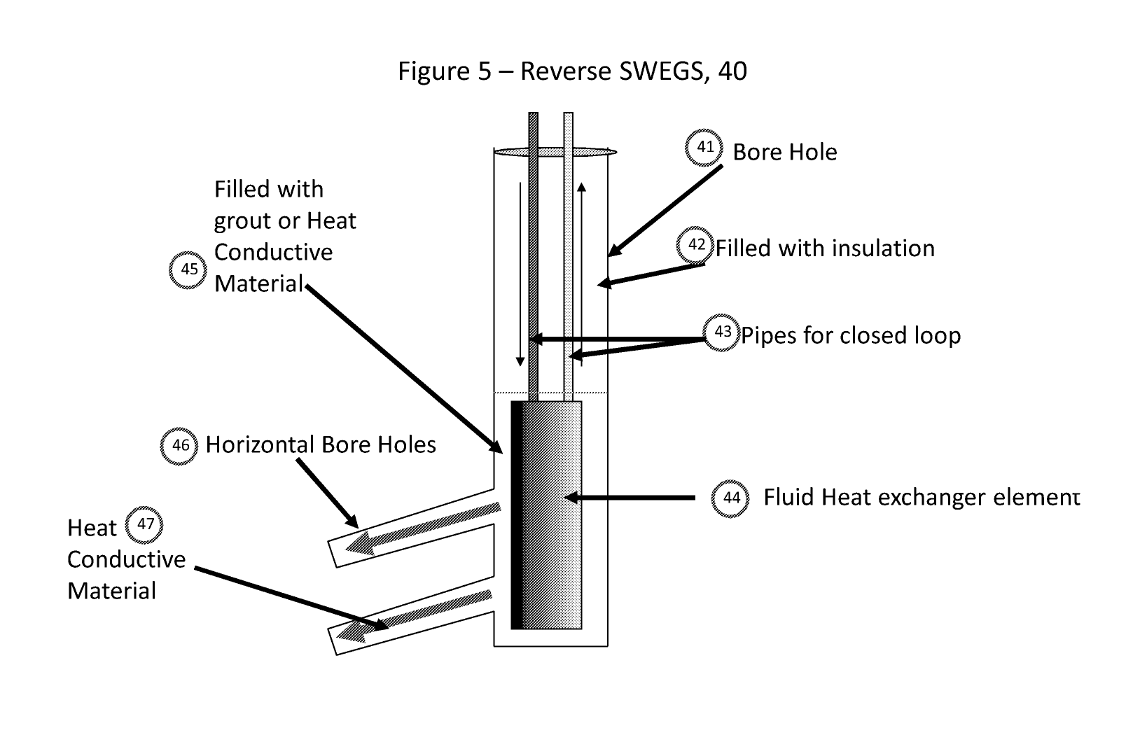

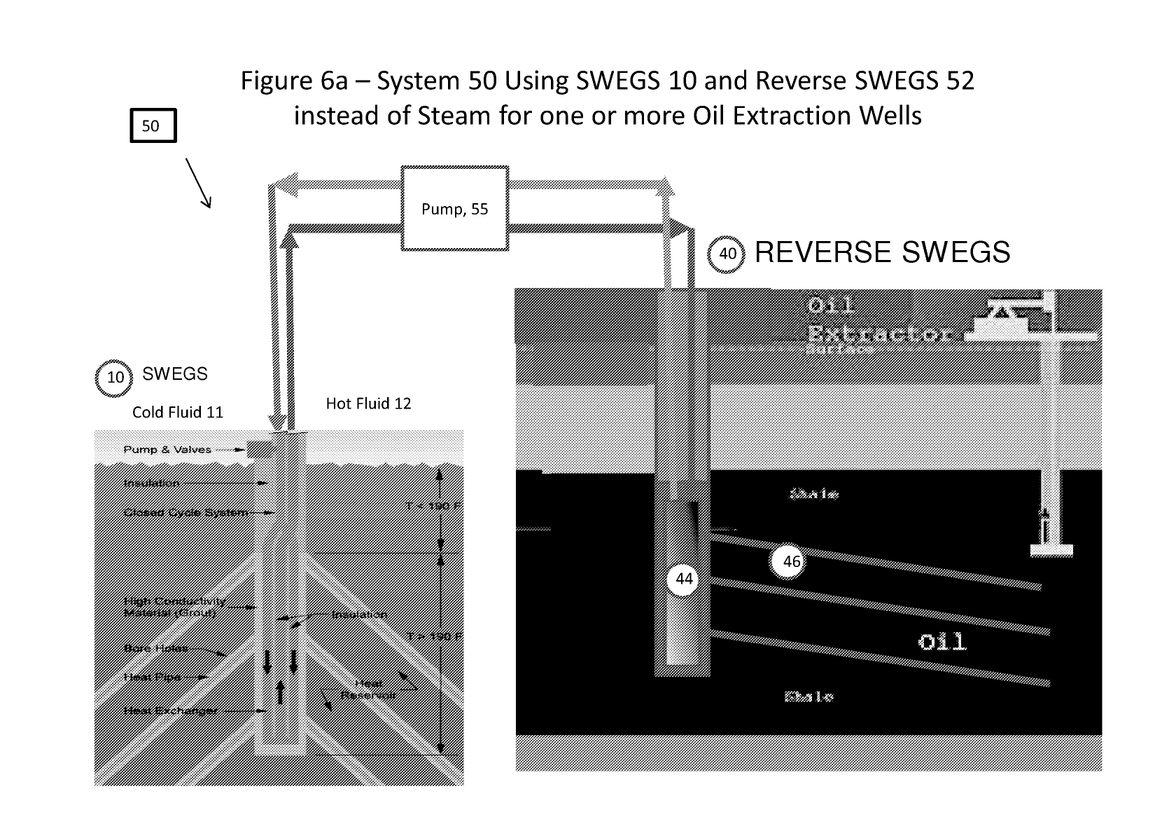

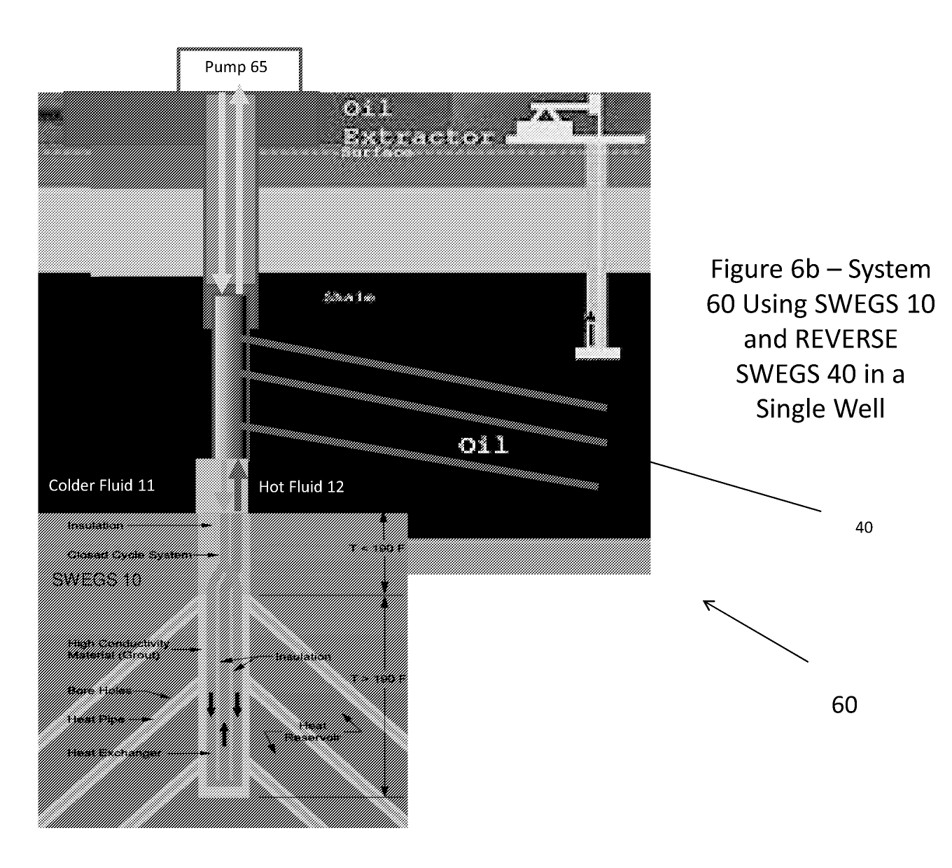

Another embodiment is to use a SWEGS (FIG. 1a) in combination with a reverse SWEGS 40 (FIG. 5) to retrieve heat from the earth and deliver the heat through a closed loop and heat conductive material to the oil deposits (FIG. 6a). There is no environmental impact by using this method. By creating heat with the earths heat and using the heat without burning any fuel there are tremendous positive benefits to the system. By supplying continuous heat to strategically targeted locations large amounts of rock or rock with a permeable fluid content can be brought to a temperature that will improve the viscosity of the trapped oil and allow the oil to be extracted. One or more SWEGS 10 can service one or more REVERSE SWEGS 40 (FIGS. 5, 6a, 6b) to service an oil field.

Another embodiment is to use the same bore hole used to install the SWEGS 10 to install a reverse SWEGS 40 as shown in FIG. 6a that delivers the heat from a deeper level in the earth to the targeted oil deposit.

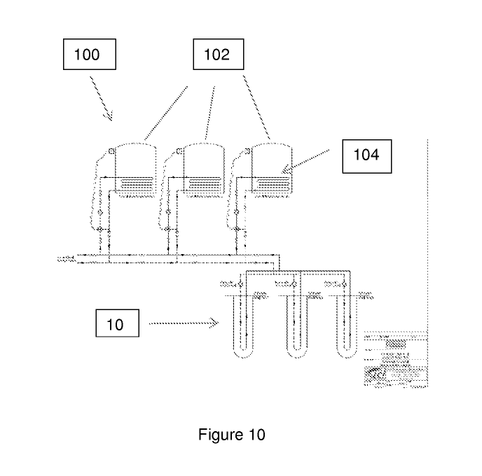

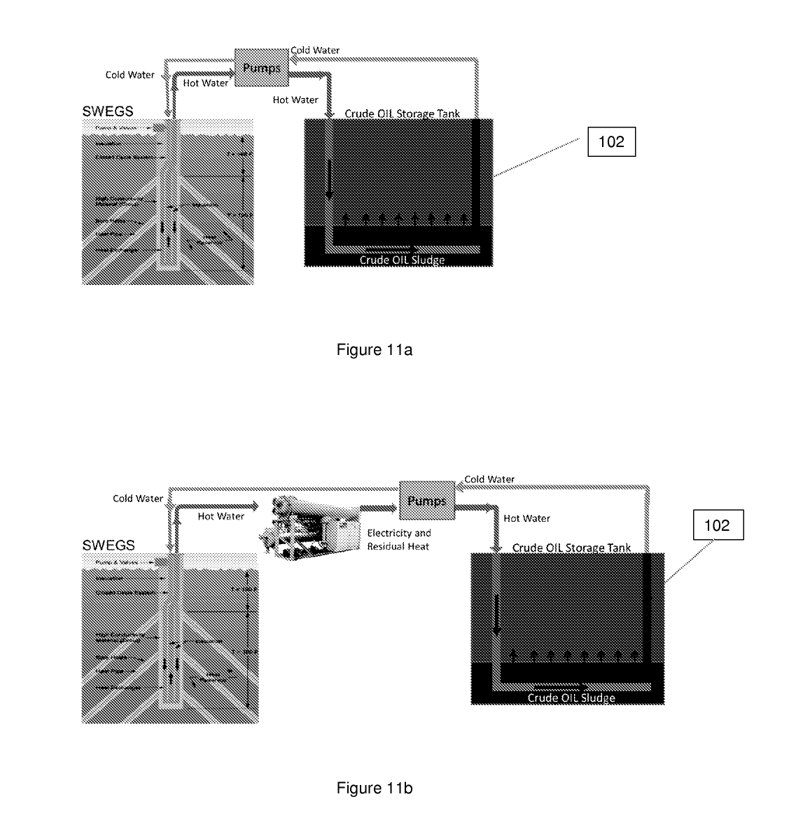

Furthermore, consistent with that shown in FIGS. 10-11, the basic approach may include using the SWEGS 10 to generate geothermal heat instead of burning fossil fuel to deliver heat to the crude oil tanks into a heavy oil deposit will significantly improve the oil recovery by improving the oil viscosity.

FIG. 15 shows another embodiment is to use SWEGS 10 in combination with heat delivery wells and hot water flooding wells in combination to retrieve heat from the earth and deliver the heat through heat deliver wells and hot water flooding wells to the oil deposits. There is no environmental impact by using this method. By creating heat with the earths heat and using the heat without burning any fuel there are tremendous positive benefits to the system. By supplying continuous heat to strategically targeted locations large amounts of the oil reservoir can be brought to a temperature that will improve the viscosity of the trapped oil and allow the oil to be extracted. One or more SWEGS 10 can service one or more heat delivery and hot water flooding wells to service an oil field.

All of the inventive approaches described herein eliminate the use of fossil fuel to create the necessary heat.

The basic approaches will now be described in detail below.

### FIG. 3-9: SWEGS-Based EOR for Oil Field

### FIG. 3: The U-Tube Configuration

FIG. 3 shows the basic approach for delivering heat from a SWEGS 10 (FIG. 1a) into a heavy oil deposit in an oil field via a U-tube configuration, according to some embodiments of the present invention. Consistent with that shown in FIG. 3, heat flow is pictorially represented by the expanding arrow at the top of FIG. 3 that is transferred from three heat absorption wells, SWEGS1, SWEGS2 and SWEGS3, shown on the right to an EOR system or apparatus shown on the left having two U-tube heat delivery wells w1 and w2. Each U-tube heat delivery well w1 and w2 is configured with a respective pump at the top, e.g., with a variable frequency drive (VFD), and corresponding piping Pi, Po for providing the heated fluid down into the U-tube heat delivery well w1, w2 via input piping Pi and back out of the U-tube heat delivery well w1, w2 via output piping Po to the SWEGS1, SWEGS2 and SWEGS3. Each U-tube heat delivery well w1 and w2 is also configured with a submersible oil pump at its bottom, as shown, that is configured to pump oil from the bottom of the well to the top of the well via an oil pipe as shown and to an oil storage tank or facility. Each SWEGS1, SWEGS2 and SWEGS3 is configured at its top as shown with a respective pump, e.g., having a Variable Frequency Drive (VFD) control for providing the heated content or fluid to the EOR system or apparatus. By way of example, the SWEGS1, SWEGS2 and SWEGS3 may be drilled to about 1000 meters, although the scope of the invention is not intended to be limited to any particular depth of a respective SWEGS. FIG. 3 also includes a well cross section shown the well, the oil discharge pipe, and heat supply and return piping.

The oil field reservoirs are typically at a depth of 2,000 to 6,000 feet and the SWEGS may be drilled to a depth 10,000 to 15,000 feet. (The oil field reservoirs are typically at a lower temperature and thus the oil has a higher viscosity, and the SWEGS are drilled deeper so as to be at a higher temperature than the oil field reservoirs.)

### FIG. 4

FIG. 4 shows a system or apparatus 30 according to the present that includes using the SWEGS 10 in an application related to providing steam in a steamflood (or steam drive) system like that shown in FIG. 2c. In effect, steam from the SWEGS can be used in a conventional steamflood or steamdrive system. The SWEGS-based technology according to the present invention is a new and unique use that eliminates the fossil fuel necessary to create steam, especially in relation to the extraction of high viscosity oil recovery.

In FIG. 4, colder fluid 11 is pumped down into the SWEGS 10 for heating and heated fluid 12 is returned to the surface, consistent with that described herein, including that related to FIG. 1a. The system or apparatus 30 includes the heat exchanger 13 (see also FIG. 1b) that is coupled to the SWEGS 10. In operation, the heated fluid is passed to the heat exchanger 13 (the heat fluid is above the boiling point of water), such that the heat is exchanged into the water 14 for creating steam 15 for injection into a steam flood system 32, as shown.

The steam flood system 32 includes a steam injector at the surface of the oil field that provides via suitable piping the steam through one or more shale layers for heating the oil in the oil field. An oil extractor as shown is configured to pump the heated oil to the surface of the oil filed.

### FIGS. 5, 6a and 6b

FIG. 5 shows a reverse SWEGS 40 which is configured from a bore hole 41 filled with insulation 42, pipes 43 for providing a closed loop system, and a fluid heat exchanger element 44 configured at the bottom of the bore hole 41 filled with grout or heat conductive material 45. The reverse SWEGS 40 is also configured with horizontal bore holes 46 and heat conductive material 47.

FIG. 6a shows a system or apparatus generally indicated as 50 according to the present invention based on, or in the form of, an application or embodiment using the SWEGS 10 (see also FIG. 1a) in conjunction with the Reverse SWEGS 40 (FIG. 5) that is used instead of steam for one or more oil extraction wells.

In this application, and consistent with that shown in FIG. 6a, a well is drilled for the installation of the reverse SWEGS 40. The reverse SWEGS 40 is configured as a closed loop system that delivers heat from the surface into an oil deposit to heat the oil in the oil field and reduce its viscosity so it will have an improved flow into the oil extraction well.

Consistent with that shown in FIG. 5, the well bore is filled with insulation for the pipes or other fluid carrying mechanisms from the earth until the depth of the oil deposit reached.

Heat is delivered through a downward flowing pipe carrying hot fluid (water or any other fluid) into the heat exchanger 44 (see also FIG. 5). After the heat exchanger 44 transfers the heat an upward flowing pipe returns the fluid to the surface for re-heating using the SWEGS heat exchange process, consistent with that described in relation to FIG. 1a.

The heat exchanger 44 delivers heat to horizontal bore holes 46 (see also FIG. 5) that were drilled and filled with heat conductive material 47 (FIG. 5). After the heat is exchanged and the fluid is cooled it returns to the surface to be reheated.

The bore hole around the heat exchanger 44 is filled with heat conductive grout or other materials that deliver the heat from the heat exchanger 44 to the horizontal bore holes 46 filled with the heat conductive material.

The one or more horizontal bore holes 46 are drilled from the vertical bore 41 (FIG. 5) into the oil deposit. The horizontal bore holes 46 containing the heat conductive material 47 carry the heat into the oil deposit (oil plume). Heat is delivered through a downward flowing pipe 43 carrying hot fluid (water or any other fluid) into the heat exchanger 44. After the heat exchanger transfers the heat an upward flowing pipe 43 returns the fluid to the surface for re-heating using the SWEGS heat exchange process.

These horizontal bore holes 46 may be strategically placed to maximize the delivery of heat into the colder rock that holds the low viscosity oil. The heat is delivered continuously and at a temperature that heats the surrounding rock or rock with a permeable fluid content and oil and allows the oil to flow into the one or more extraction wells, as shown. The horizontal bore holes 46 can be drilled in any direction so that a single reverse SWEGS can impact the oil deposits in all directions and could be used for multiple oil extraction wells.

Highly conductive material 47 (FIG. 5) carries the heat form the heat exchanger 44 into the rock containing the oil. Providing continuous heat allows the rock or rock with a permeable fluid content surrounding the horizontal bore holes 46 to conduct the heat to rock or rock with a permeable fluid content that is further away from the horizontal bore holes 46 extending the reach of the system 50. By way of example, the conductive material 47 (FIG. 5) can be any of the following forms of heat conductive material and configurations:

### Rods,

### Heat Pipes,

Mesh of wire,

### Beads/spheres,

### Foam,

### Plastics,

### Ceramics,

### Crystals,

### Closed Loops,

### Metals,

### Carbons,

### Powders,

Polymers, and/or

### Fluids.

The scope of the invention is also intended to include other types or kinds of heat conductive material either now known or later developed in the future.

FIG. 6b shows a system or apparatus generally indicated as 60 according to the present invention based on, or in the form of, an application or embodiment using the SWEGS 10 and a reverse SWEGS 40 in a single well instead of steam for one or more oil extraction wells

By way of example, under certain conditions it may be advantageous to use the same bore hole to deliver heat from a SWEGS like 10 (FIG. 1a) that is installed in a deeper bore to a reverse SWEGS like 40 installed at a shallower point in the vertical bore.

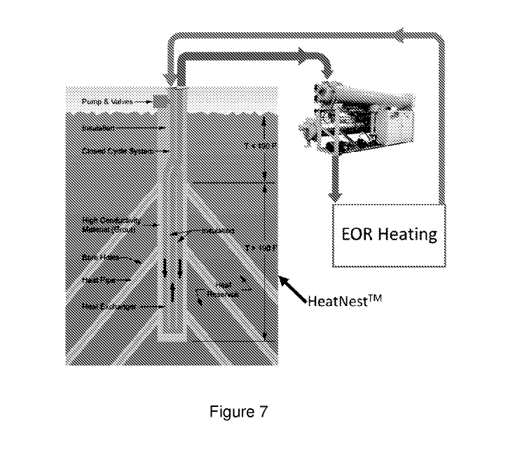

### FIG. 7: The Power Plant

FIG. 7 shows an embodiment according to the present invention in which a SWEGS 10 that is used in conjunction with a power plant for generating electricity may also be used in conjunction with an EOR system or apparatus for heating according to the present invention. In this application, if there is enough heat captured in the well bore, a power plant using the SWEGS technology can be constructed and the residual heat from the power plant can be used for, or in relation to, the EOR system or apparatus. This scenario maximizes the IRR. If there is enough heat for a power plant the geothermal reserves on the property can be added to the balance sheet as an asset. In operation, the heat extraction system (SWEGS 10) is configured to provide the heated content to the power plant, and the enhanced oil recovery system or apparatus is configured to receive the heated content from the power plant having residual heat and to deliver heat content to the oil in the oil reservoir, such that the power plant can be used for, or in conjunction with, enhanced oil recovery.

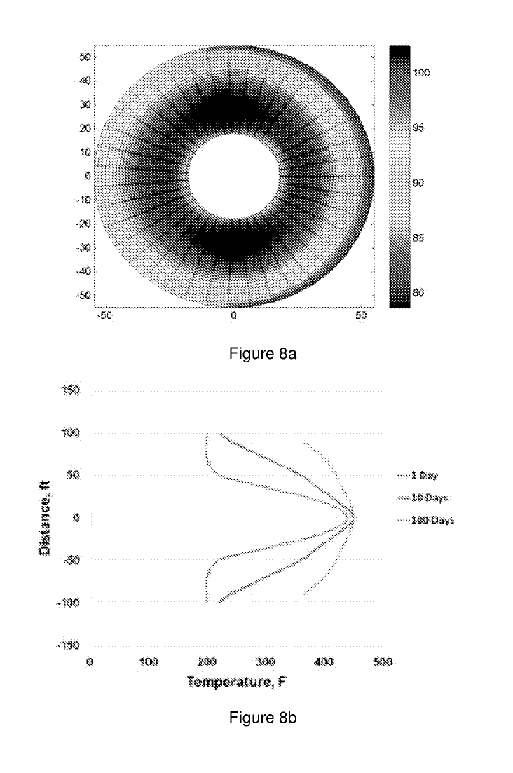

### FIGS. 8a, 8b and 8c

FIGS. 8a, 8b and 8c provides some background as to why constant consistent heating of the oil field spreads the heat and increases flow. As a person skilled in the art would appreciate, heat moves through oil in the oil field through conduction, consistent with that shown in FIGS. 8a, 8b. Further, as a person skilled in the art would appreciate, heat also moves through toroidal convection of water and oil in permeable zones, consistent with that shown in FIG. 8c.

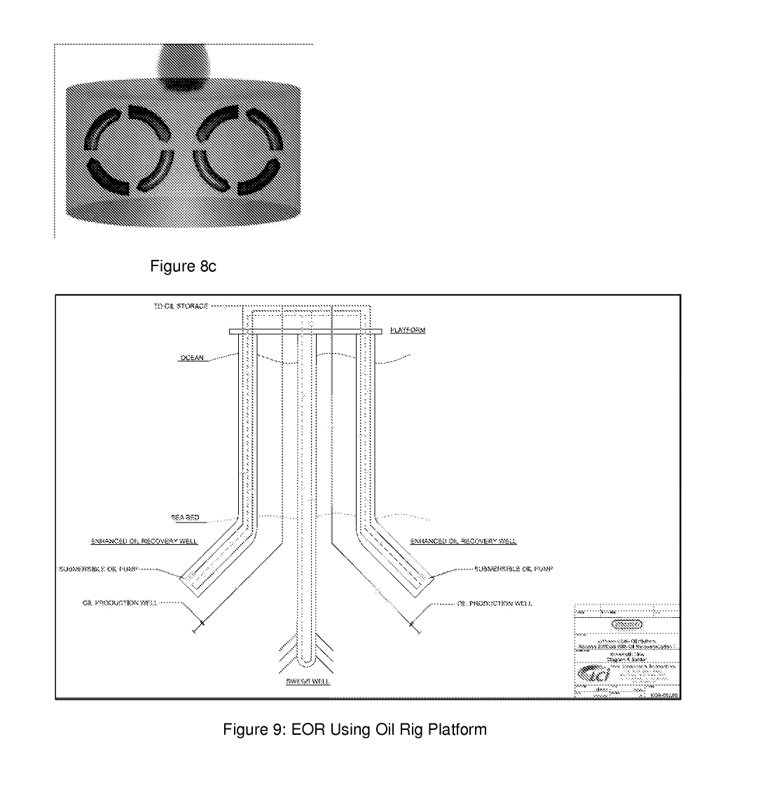

### FIG. 9

FIG. 9 show apparatus according to some embodiments of the present invention, where the apparatus may include, or form part of, an oil rig configured to couple the heat extraction system SWEGS 10) to the enhanced oil recovery system or apparatus in relation to a surrounding body of water and a seabed.

### FIGS. 10-11: SWEGS-Based EOR for Storage Tanks

FIGS. 10-11 show a system or apparatus generally indicated as 100 according to the present invention in which a SWEGS 10 is adapted or configured in relation to one or more storage tanks 102 so as to form a SWEGS-based EOR system or apparatus, as shown.

According to the embodiment shown in FIG. 10, the oil reservoir may alternatively be, or take the form of, the one or more storage tanks 102 containing the oil, and the enhanced oil recovery apparatus may be configured to provide the heated content to the one or more storage tanks 102 in order to the heat the oil contained therein.

The enhanced oil recovery apparatus may include a combination of one or more pumps, e.g., having a VFD control, as shown, and one or more pipes or piping as shown configured to provide the heated content to the one or more storage tanks 102 that hold high viscosity oil.

The one or more pipes may be configured to provide the heated content to the bottom of the storage tank, e.g., via a heat coil 104, configured at the bottom of the storage tank and also configured to receive the heated content from the one or more pipes.

The enhanced oil recovery apparatus may be configured to deliver the heat continuously and at a temperature that heats the oil in the one or more storage tanks lowering the viscosity of the oil, consistent with that set forth herein.

The enhanced oil recovery apparatus may be configured to create a toroidal-convection effect to lower the viscosity of tank bottom crude oil sludge and prevent or minimize the formation of crude oil sludge, consistent with that set forth herein.

According to embodiment shown in FIGS. 11a and 11b, the system or apparatus 100 may be configured with or without a power plant consistent with that disclosed in relation to FIG. 17

In FIGS. 11a and 11b, the apparatus is shown with pumps configured to provide the heated content from the heat extraction system (SWEGS 10) to the storage tanks, and cooled fluid from storage tanks 102 the to the SWEGS 10.

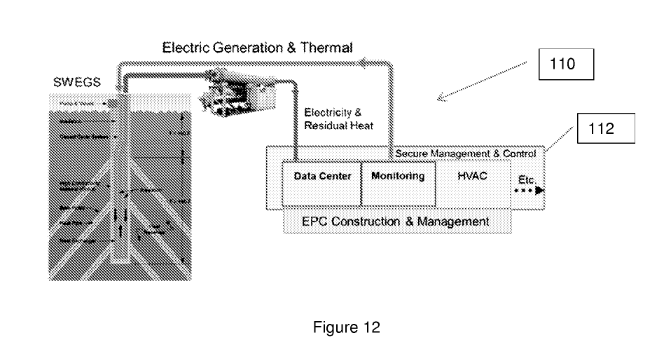

### FIG. 12

FIG. 12 show a system or apparatus generally indicated as 110 according to the present invention in which a SWEGS 10 is adapted or configured in relation to a power plant and a controller 112 is configured to perform secure management and control functionality, e.g., including data center, monitoring and HVAC functionality, that itself forms part of EPC construction and management functionality.

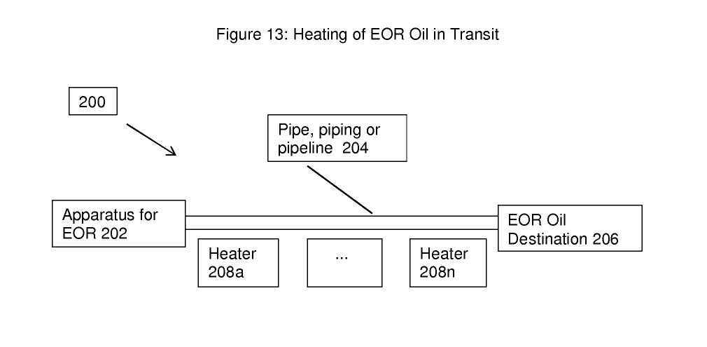

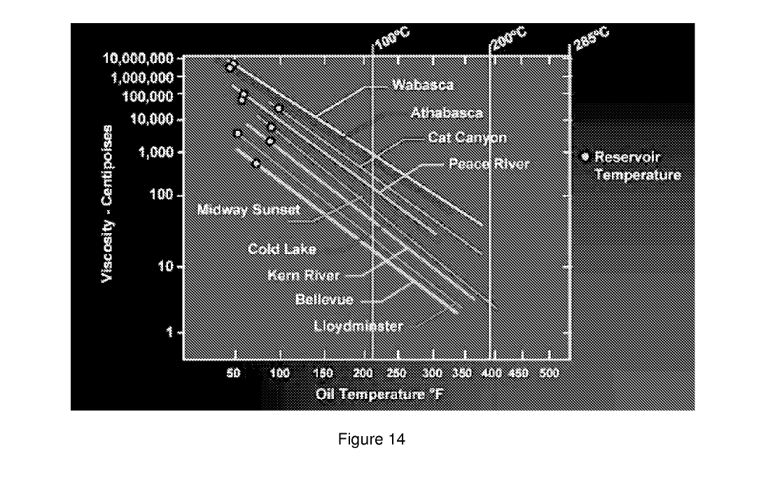

### FIG. 13: Heating of Oil from EOR Process During its Transport

FIG. 13 shows a system or apparatus generally indicated as 200 according to some embodiments of the present invention for heating of oil recovered in the EOR process when it is being transported from an apparatus or system 202 for EOR via a pipe, piping or pipeline 204 to an EOR oil destination 206 using one or more heaters 208a, . . . , 208n.

Depending on a number of parameters, e.g., including the number of miles between the apparatus or system 202 for EOR and the EOR oil destination 206, the insulation of the pipe, piping or pipeline 204, and the ambient temperature along the way between the apparatus or system 202 for EOR and the EOR oil destination 206, the oil recovered in the EOR process disclosed herein may need to be heated during its transit from the apparatus or system 202 for EOR to the EOR oil destination 206. For example, if the number of miles between the apparatus or system 202 for EOR and the EOR oil destination 206, the insulation coefficient of the pipe, piping or pipeline 204 and the ambient temperature along the way combine in such a way to cause the temperature of the oil recovered in the EOR process to lose heat, then the oil recovered in the EOR process may become too cold when being transported, and thus become too viscous. If the oil recovered in the EOR process becomes too cold, e.g., as cold as it was before it was recovered, then it is will turn back to sludge, which will have a significant impact on the ability to transport the same from the apparatus or system 202 for EOR to the EOR oil destination 206 via the pipe, piping or pipeline 204.

In order to substantially prevent this from happening, the one or more heaters 208a, . . . , 208n may be strategically configured along the pipe, piping or pipeline 204 between the apparatus or system 202 for EOR and the EOR oil destination 206. A person skilled in the art would be able to determine the number and arrangement of the heaters 208a, . . . , 208n between the apparatus or system 202 for EOR and the EOR oil destination 206 so as to maintain the oil recovered in the EOR process at at least a certain desired temperature during its transit, based at least partly on knowing the number of miles between the apparatus or system 202 for EOR and the EOR oil destination 206, the insulation coefficient of the pipe, piping or pipeline 204, and the ambient temperature along the way between the apparatus or system 202 for EOR and the EOR oil destination 206.

The apparatus or system 202 for EOR is understood to include the apparatus or system for EOR of oil recovered from an oil field consistent with that disclosed herein in relation to FIGS. 3-9 herein, as well as to include the apparatus or system for EOR of oil recovered from a storage tank consistent with that disclosed herein in relation to FIGS. 10-11 herein. The scope of the invention is intended to include the transportation of the oil recovered directly from the apparatus or system 202 for EOR via the pipe, piping or pipeline 204, as well as the transportation of the oil recovered, which has been temporarily stored at or near the apparatus or system 202 for EOR before being transported via the pipe, piping or pipeline 204.

Heaters that may be configured in relation to a pipe, piping, or pipeline like element 204 are known in the art, and the scope of the invention is not intended to be limited to any particular type or kind thereof either now known or later developed in the future. Moreover, the scope of the invention is not intended to be limited to the number of the heaters 208a, . . . , 208n configured between the apparatus or system 202 for EOR and the EOR oil destination 206 along the pipe, piping or pipeline 204.

When the oil recovered from the EOR process reaches the EOR oil destination 206 at the desired temperature, it will be further processed using techniques that are known in the art, and that do not form part of the underlying invention disclosed herein.

### FIG. 15

FIG. 15 shows a primary implementation or system of the present invention. The technique can be applied to depleted wells, underperforming wells or oil fields that have not been exploited. The system uses current oil/water brine production wells or production wells are drilled. In addition to one of the aforementioned wells, the following additional wells may also be drilled:

1. One or more SWEGS Heat Extraction well are drilled,

2. One or more Heat Delivery wells are drilled, and

3. One or more Hot Water Flooding wells are drilled.

In operation, heat is extracted from the one or more SWEGS well and transferred to the one or more heat delivery wells. The heat is transferred into the oil reservoir. As oil and brine flows into the production wells, it is brought to the surface with one or more pumps. The oil is then separated from the water/brine by an oil and water/brine separator, and the oil is stored for delivery. The water/brine is heated in a heat exchanger, using heat from the SWEGS heat extraction well, and pumped back into the oil reservoir under pressure. The heated water/brine then helps lower the viscosity of the oil and creates pressure in the oil reservoir thereby helping to cause the oil to flow. The cycle is repeated over and over in order recover oil from the oil reservoir.

### SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawing herein is not necessarily drawn to scale.

Although the invention has been described and illustrated with respect to exemplary embodiments thereof, the foregoing and various other additions and omissions may be made therein and thereto without departing from the spirit and scope of the present invention.

We claim:

1. Apparatus comprising:
a heat extraction system for generating geothermal heat from within a drilled well, comprising:
a heat conductive material injected into an area within a heat nest near a bottom of a drilled well between a heat exchanging element and rock, or rock with a permeable fluid content, surrounding the heat nest to form a closed-loop solid state heat exchange to heat contents of a piping system flowing into and out of the heat exchanging element at an equilibrium temperature at which the rock, or rock with a permeable fluid content, surrounding the heat nest and generating the geothermal heat continually recoups the geothermal heat that the rock, or rock with a permeable fluid content, is conducting to the heat conductive material and above which the geothermal heat generated by the rock, or rock with a permeable fluid content, surrounding the heat nest dissipates as the heat conductive material conducts heat from the rock, or rock with a permeable fluid content, surrounding the heat nest to the heat exchanging element,
the heat conductive material configured to solidify to substantially fill the area within the heat nest to transfer heat from the rock, or rock with a permeable fluid content, surrounding the heat nest and the heat exchanging element,
the piping system configured to bring the contents from a surface of the well into the heat nest and carry heated contents to the surface of the well from the heat nest, and
the closed-loop solid state heat exchange configured to extract geothermal heat from the well without exposing the rock, or rock with a permeable fluid content, surrounding the heat nest to a liquid flow, and provide heated contents to the piping system for further processing; and
an enhanced oil recovery apparatus configured to receive the heated content and to further process the heated content in order to deliver heat to oil in an oil reservoir to decrease substantially the viscosity of the oil and increase substantially oil recovery of the oil in the oil reservoir.
Oil Field Recovery

2. Apparatus according to claim 1, wherein the oil reservoir is, or takes the form of, an underground oil field containing the oil, and the enhanced oil recovery apparatus is configured to provide the heated content to the underground oil field.

3. Apparatus according to claim 2, wherein the heated content includes heated fluid or steam.

4. Apparatus according to claim 2, wherein the enhanced oil recovery apparatus comprises a reverse heat extraction system having one or more heat pipes configured in one or more horizontal bore holes drilled into the oil reservoir and configured to receive the heated content.

5. Apparatus according to claim 2, wherein the enhanced oil recovery apparatus is configured with pipes or piping to provide steam from a heat exchanger coupled to heat extraction system to a steam injector that forms part of steamflood or steam drive system configured in the underground oil field.

6. Apparatus according to claim 2, wherein the enhanced oil recovery apparatus comprises a reverse heat extraction system configured in the underground oil field and having pipes or piping and a heat exchanger element and configured to receive the heated content from the heat extraction system and provide the heated content to the underground oil field.

7. Apparatus according to claim 2, wherein the enhanced oil recovery apparatus comprises a reverse heat extraction system configured together with the heat extraction system in a single well in the underground oil field.

8. Apparatus according to claim 7, wherein the reverse heat extraction system is configured to receive the heated content from the heat extraction system in the single well in the underground oil field, and provide the heated content to the underground oil field.

9. Apparatus according to claim 4, wherein the one or more heat pipes are configured to provide continuous heat that allows the rock, or rock with a permeable fluid content, surrounding the horizontal bores to conduct the heat to the rock that is further away from the horizontal bores extending the reach of the apparatus.

10. Apparatus according to claim 4, wherein the enhanced oil recovery apparatus comprises a downwardly flowing pipe configured to carry hot fluid to a heat exchanger to delivery the heat into the rock that holds the high viscosity oil, and an upwardly flowing pipe configured to return cooled fluid to the surface to be reheated by the heat extraction system after the heat is exchanged.

11. Apparatus according to claim 2, wherein the heat extraction system is configured to provide the heated content to a power plant, and the enhanced oil recovery apparatus is configured to receive the heated content from the power plant having residual heat and to deliver heat content to the oil in the oil reservoir, such that the power plant can be used for, or in conjunction with, enhanced oil recovery.

12. Apparatus according to claim 2, wherein the apparatus further comprises an oil rig configured to couple the heat extraction system to the enhanced oil recovery apparatus in relation to a surrounding body of water and a seabed.
Storage Tanks

13. Apparatus according to claim 1, wherein the oil reservoir is, or takes the form of, one or more storage tanks containing the oil, and the enhanced oil recovery apparatus is configured to provide the heated content to the storage tank in order to the heat the oil contained therein.

14. Apparatus according to claim 13, wherein the enhanced oil recovery apparatus comprises a combination of one or more pumps and one or more pipes configured to provide the heated content to the one or more storage tanks that hold high viscosity oil.

15. Apparatus according to claim 14, wherein the one or more pipes are configured to provide the heated content to the bottom of the storage tank.

16. Apparatus according to claim 15, wherein the enhanced oil recovery apparatus comprises a heating coil configured at the bottom of the storage tank and also configured to receive the heated content from the one or more pipes.

17. Apparatus according to claim 14, wherein the enhanced oil recovery apparatus is configured to deliver the heat continuously and at a temperature that heats the oil in the one or more storage tanks lowering the viscosity of the oil.

18. Apparatus according to claim 14, wherein the enhanced oil recovery apparatus is configured to create a toroidal-convection effect to lower the viscosity of tank bottom crude oil sludge and prevent or minimize the formation of crude oil sludge.

19. Apparatus according to claim 1, wherein the apparatus comprises pumps configured to provide the heated content from the heat extraction system to the enhanced oil recovery apparatus, and cooled fluid from the enhanced oil recovery apparatus to the heat extraction system.
Method claim Set

20. A method comprising:
generating with a heat extraction system geothermal heat from within a drilled well, using the following steps:
injecting a heat conductive material into an area within a heat nest near a bottom of a drilled well between a heat exchanging element and rock, or rock with a permeable fluid content, surrounding the heat nest to form a closed-loop solid state heat exchange to heat contents of a piping system flowing into and out of the heat exchanging element at an equilibrium temperature at which the rock, or rock with a permeable fluid content, surrounding the heat nest and generating the geothermal heat continually recoups the geothermal heat that the rock, or rock with a permeable fluid content, is conducting to the heat conductive material and above which the geothermal heat generated by the rock surrounding the heat nest dissipates as the heat conductive material conducts heat from the rock, or rock with a permeable fluid content, surrounding the heat nest to the heat exchanging element,
substantially filing and solidifying the heat conductive material in the area within the heat nest to transfer heat from the rock, or rock with a permeable fluid content, surrounding the heat nest and the heat exchanging element,
bringing with the piping system the contents from a surface of the well into the heat nest and carry heated contents to the surface of the well from the heat nest, and
extracting with the closed-loop solid state heat exchange geothermal heat from the well without exposing the rock, or rock with a permeable fluid content, surrounding the heat nest to a liquid flow, and provide heated contents to the piping system for further processing; and
receiving with an enhanced oil recovery apparatus the heated content and further processing the heated content in order to deliver heat to oil in an oil reservoir to decrease substantially the viscosity of the oil and increase substantially oil recovery of the oil in the oil reservoir.
Oil Field Recovery

21. A method according to claim 1, wherein the oil reservoir is, or takes the form of, an underground oil field containing the oil, and the method comprises providing with the enhanced oil recovery apparatus the heated content to the underground oil field.

22. A method according to claim 21, wherein the heated content includes heated fluid or steam.

23. A method according to claim 21, wherein the method comprises arranging in the underground oil field a reverse heat extraction system having one or more heat pipes configured in one or more horizontal bore holes drilled into the oil reservoir and configured to receive the heated content.

24. A method according to claim 21, wherein the method comprises providing from pipes or piping that form part of the enhanced oil recovery apparatus steam from a heat exchanger coupled to heat extraction system to a steam injector that forms part of steamflood or steam drive system configured in the underground oil field.

25. A method according to claim 21, wherein the method comprises arranging in the underground oil field a reverse heat extraction system that has pipes or piping and a heat exchanger element and is configured to receive the heated content from the heat extraction system and provide the heated content to the underground oil field.

26. A method according to claim 21, wherein the method comprises arranging in the underground oil field a reverse heat extraction system configured together with the heat extraction system in a single well in the underground oil field.

27. Apparatus according to claim 26, wherein the reverse heat extraction system is configured to receive the heated content from the heat extraction system in the single well in the underground oil field, and provide the heated content to the underground oil field.

28. A method according to claim 23, wherein the method comprises providing with the one or more heat pipes continuous heat that allows the rock, or rock with a permeable fluid content, surrounding the horizontal bores to conduct the heat to the rock that is further away from the horizontal bores extending the reach of the apparatus.

29. A method according to claim 23, wherein the method comprises configuring a downwardly flowing pipe that forms part of the enhanced oil recovery apparatus to carry hot fluid to a heat exchanger to delivery the heat into the rock that holds the high viscosity oil, and an upwardly flowing pipe that forms part of the enhanced oil recovery apparatus to return cooled fluid to the surface to be reheated by the heat extraction system after the heat is exchanged.

30. A method according to claim 27, wherein the method comprises configuring the heat extraction system to provide the heated content to a power plant, and configuring the enhanced oil recovery apparatus to receive the heated content from the power plant having residual heat and delivering the heat content to the oil in the oil reservoir, such that the power plant can be used for, or in conjunction with, enhanced oil recovery.

31. A method according to claim 21, wherein the method comprises configuring an oil rig to couple the heat extraction system to the enhanced oil recovery apparatus in relation to a surrounding body of water and a seabed.
Storage Tanks

32. A method according to claim 20, wherein the oil reservoir is, or takes the form of, one or more storage tanks containing the oil, and the method comprises providing with the enhanced oil recovery apparatus the heated content to the storage tank in order to the heat the oil contained therein.

33. A method according to claim 32, wherein the method comprises providing with a combination of one or more pumps and one or more pipes that forms part of the enhanced oil recovery apparatus the heated content to the one or more storage tanks that hold high viscosity oil.

34. A method according to claim 33, wherein the method comprises providing with the one or more pipes the heated content to the bottom of the storage tank.

35. A method according to claim 34, wherein the method comprises configuring a heating coil that forms part of the enhanced oil recovery apparatus at the bottom of the storage tank and that receives the heated content from the one or more pipes.

36. A method according to claim 33, wherein the method comprises continuously delivering with the enhanced oil recovery apparatus the heat at a temperature that heats the oil in the one or more storage tanks lowering the viscosity of the oil.

37. A method according to claim 33, wherein the method comprises creating with the enhanced oil recovery apparatus a toroidal-convection effect to lower the viscosity of tank bottom crude oil sludge and prevent or minimize the formation of crude oil sludge.

38. A method according to claim 20, wherein the method comprises using pumps configured to provide the heated content from the heat extraction system to the enhanced oil recovery apparatus, and to provide cooled fluid from the enhanced oil recovery apparatus to the heat extraction system.

39. Apparatus according to claim 4, wherein the one or more heat pipes are placed to delivery the heat into rock that holds high viscosity oil.

40. Apparatus according to claim 5, wherein the enhanced oil recovery apparatus is configured to deliver the heat continuously and at a temperature that heats surrounding rock lowering the viscosity of the oil and allowing the oil to flow into a nearby extraction well.

41. Apparatus according to claim 4, wherein the one or more horizontal bore holes drilled into the oil reservoir are drilled in any direction so that a single heat extraction system can impact oil deposits in all directions and can be used for multiple oil extraction wells.

42. Apparatus according to claim 4, wherein the one or more heat pipes are configured to carry the heat from the heat exchanger into the rock containing the oil.

43. Apparatus according to claim 1, wherein the heat conductive material is select from a group comprised of:
Rods,
Heat Pipes,
Mesh of wires,
Beads/spheres,
Foam,
Plastics,
Ceramics,
Crystals,
Closed Loops,
Metals,
Carbons,
Powders, and/or
Fluids.

44. A method according to claim 21, wherein the method comprises configuring one or more heat pipes that form part of the enhanced oil recovery apparatus in one or more horizontal bore holes drilled into the oil reservoir.

45. A method according to claim 44, wherein the method comprises placing the one or more heat pipes to delivery the heat into rock that holds high viscosity oil.

46. A method according to claim 44, wherein the method comprises continuously delivering with the enhanced oil recovery apparatus the heat at a temperature that heats surrounding rock lowering the viscosity of the oil and allowing the oil to flow into a nearby extraction well.

47. A method according to claim 44, wherein the method comprises drilling the one or more horizontal bore holes into the oil reservoir in any direction so that a single heat extraction system can impact oil deposits in all directions and can be used for multiple oil extraction wells.

48. A method according to claim 44, wherein the method comprises configuring the one or more heat pipes to carry the heat from the heat exchanger into the rock containing the oil.

49. Apparatus comprising:
means for generating geothermal heat from within a drilled well, using the following steps: injecting a heat conductive material into an area within a heat nest near a bottom of a drilled well between a heat exchanging element and rock surrounding the heat nest to form a closed-loop solid state heat exchange to heat contents of a piping system flowing into and out of the heat exchanging element at an equilibrium temperature at which the rock surrounding the heat nest and generating the geothermal heat continually recoups the geothermal heat that the rock is conducting to the heat conductive material and above which the geothermal heat generated by the rock surrounding the heat nest dissipates as the heat conductive material conducts heat from the rock surrounding the heat nest to the heat exchanging element, substantially filing and solidifying the heat conductive material in the area within the heat nest to transfer heat from the rock surrounding the heat nest and the heat exchanging element, bringing with the piping system the contents from a surface of the well into the heat nest and carry heated contents to the surface of the well from the heat nest, and extracting with the closed-loop solid state heat exchange geothermal heat from the well without exposing the rock surrounding the heat nest to a liquid flow, and provide heated contents to the piping system for further processing; and
means for receiving the heated content and further processing the heated content in order to deliver heat to oil in an oil reservoir to decrease substantially the viscosity of the oil and increase substantially oil recovery of the oil in the oil reservoir.

50. Apparatus according to claim 1, wherein the apparatus comprises a further system or apparatus for heating of the oil recovered when being transported from the apparatus via a pipe, piping or pipeline to an EOR oil destination using one or more heaters.

51. Apparatus according to claim 50, wherein the one or more heaters are configured in relation to the pipe, piping or pipeline based at least partly on a number of parameters, including the number of miles between the apparatus and the EOR oil destination, an insulation coefficient of the pipe, piping or pipeline, and the ambient temperature along the way between the apparatus and the EOR oil destination.

52. A method according to claim 20, wherein the method comprises heating of the oil recovered when being transported from the apparatus via a pipe, piping or pipeline to an EOR oil destination using one or more heaters.

53. A method according to claim 52, wherein the method comprises configuring the one or more heaters in relation to the pipe, piping or pipeline based at least partly on a number of parameters, including the number of miles between the apparatus and the EOR oil destination, an insulation coefficient of the pipe, piping or pipeline, and the ambient temperature along the way between the apparatus and the EOR oil destination.

54. Apparatus according to claim 1, wherein the enhanced oil recovery apparatus comprises at least one U-tube heat delivery well configured with a respective pump and corresponding piping for providing the heated content down into the at least one U-tube heat delivery well via input piping and back out of the U-tube heat delivery well via output piping.

55. Apparatus according to claim 1, wherein the enhanced oil recovery apparatus comprises the at least one U-tube heat delivery well is also configured with a submersible oil pump that is configured to pump oil from the bottom of the at least one U-tube heat delivery well via an oil pipe.

56. Apparatus according to claim 1, wherein the apparatus comprises additional wells, a pump, an oil and water/brine separator and a heat exchanger;
the additional wells including
3. A Heat Delivery well, and
4. A Hot Water Flooding well;
the heat extraction system is configured to transfer the heat content to the heat delivery well;
the heat delivery well is configured to transfer heat into the oil reservoir;
one or more pumps are configured to provide oil and water/brine water from a production well to the surface; and
the oil and water/brine separator is configured to separate oil from the water/brine.

57. Apparatus according to claim 56, wherein the heat exchanger is configured to heat the water/brine, using heat from the heat extraction system.
